(19) United States
(12) Patent Application Publication
(10) Pub. No.: US 2011/0061786 A1
(43) Pub. Date: Mar. 17, 2011

(54) PROCESS FOR MAKING CUSTOMIZED PARTICLES BY STOCHASTIC EXCITATION

(75) Inventor: Thomas G. Mason, Los Angeles, CA (US)

(73) Assignee: The Regents of the University of California, Oakland, CA (US)

(21) Appl. No.: 12/882,731

(22) Filed: Sep. 15, 2010

Related U.S. Application Data
(60) Provisional application No. 61/242,639, filed on Sep. 15, 2009.

(51) Int. Cl. B29B 9/16; B29C 35/08; B29C 35/02

(52) U.S. Cl. 156/62.2; 264/442; 264/239; 216/52

(57) ABSTRACT

A method of producing a particle includes fabricating a precursor particle structure that has a first sub-structure, a second sub-structure proximate the first sub-structure and an interconnecting sub-structure connected to the first and second sub-structures, the precursor particle structure being in a first configuration; and exposing the precursor particle structure to a stochastic excitation process to cause a deformation of the interconnecting sub-structure to reconfigure at least one of a position and an orientation of the first sub-structure relative to the second sub-structure from the first configuration to form the particle in a second configuration. The first sub-structure and the second sub-structure are substantially free of deformation during the exposing, and a maximal spatial dimension of the particle in the second configuration is less than about one millimeter. A multi-component composition has a first material component, and a plurality of particles produced according to methods of the current invention that are dispersed in the first material component. A maximal spatial dimension of each of the plurality of particles is less than about 10 micrometers, and the plurality of particles is at least 10 particles.

### CROSS-REFERENCE TO RELATED APPLICATION

This application claims priority to U.S. Provisional Application No. 61/242,639 filed Sep. 15, 2009, the entire contents of which are hereby incorporated by reference.

### BACKGROUND

1. Field of Invention

This application relates to processes of making particles and compositions of the particles, and more particularly to processes of making particles and compositions of the particles made by inducing reconfiguration of one or more internal sub-structures of the particles by excitations in which a maximal spatial dimension each particle is less than about one millimeter.

2. Discussion of Related Art

The contents of all references, including articles, published patent applications and patents referred to anywhere in this specification are hereby incorporated by reference.

Lithographic methods (Madou, M. J. Fundamentals of microfabrication: The science of miniaturization. 2nd ed.; CRC Press: Boca Raton, 2002) can be used to design and mass-produce large numbers of rigid custom-shaped particles, which can be dispersed in a fluid (Hernandez, C. J.; Mason, T. G. Colloidal alphabet soup: Monodisperse dispersions of shape-designed LithoParticles. J. Phys. Chem. C 2007, 111, 4477-4480; Hernandez, C. J.; Zhao, K.; Mason, T. G. Pillar-deposition particle templating: A high-throughput synthetic route for producing LithoParticles. Soft Materials 2007, 5, 1-11; Hernandez, C. J.; Zhao, K.; Mason, T. G. Well-deposition particle templating: Rapid mass-production of LithoParticles without mechanical imprinting. Soft Materials 2007, 5, 13-31; Higurashi, E.; Ukita, H.; Tanaka, H.; Ohguchi, O. Optically induced rotation of anisotropic micro-objects fabricated by surface micromachining. Appl. Phys. Lett. 1994, 64, 2209-2210; Rolland, J. P.; Maynor, B. W.; Euliss, L. E.; Exner, A. E.; Denison, G. M.; DeSimone, J. M. Direct fabrication of monodisperse shape-specific nanobiomaterials through imprinting. J. Am. Chem. Soc. 2005, 127, 10096-10100; Brown, A. B. D.; Smith, C. G.; Rennie, A. R. Fabricating colloidal particles with photolithography and their interactions at an air-water interface. Phys. Rev. E 2000, 62, 951-960; Sullivan, M.; Zhao, K.; Harrison, C.; Austin, R. H.; Megens, M.; Hollingsworth, A.; Russel, W. B.; Cheng, Z.; Mason, T. G.; Chaikin, P. M. Control of colloids with gravity, temperature gradients, and electric fields. J. Phys. Condens. Matter 2003, 15, S11-S18). In addition to top-down lithographic methods that facilitate the direct design of millimeter and sub-millimeter particles that have customized shapes and sizes, non-spherical particles can also be made and sometimes even designed by bottom-up processes, such as growth of colloidal particles (e.g. nanorods) or self-assembly of nanostructures in solution (Whitesides, G. M.; Boncheva, M. Beyond molecules: self-assembly of mesoscopic and macroscopic components. 2002, Proc. Nat. Acad. Sci., 99, 4769-4774). Regardless of the methods of production, having a means of designing the shapes and sizes of the particles is potentially useful for creating desired particle shapes and sizes that may have enhanced functionality owing to pre-specified geometrical features inherent in their shapes and sizes. However, in some cases, limitations of top-down lithographic methods restrict the range of sizes and shapes of particles that can be created in an efficient and cost-effective manner. Likewise, limitations of bottom-up self-assembly also restrict the range of sizes and shapes of particles that can be created in an efficient and cost-effective manner.

An important current challenge in the area of materials fabrication is the mass-production of low-defect, discrete, high-complexity structures at small length scales. Some approaches exist for creating self-assembled structures involving liquids, including scaffolded DNA origami (Rothemund, P. W. K. Folding DNA to create nanoscale shapes and patterns. Nature, 2006, 440, 297-302), capillary origami (Py, C.; Reverdy, P.; Doppler, L.; Bico, J.; Roman, B.; Baroud, C. N. Capillary origami: spontaneous wrapping of a droplet with an elastic sheet. Phys. Rev. Lett. 2007, 98, 156103/1-4), and cluster aggregation (Manoharan, V. N.; Elsesser, M. T.; Pine, D. J. Dense packing and symmetry in small clusters of microspheres. Science 2003, 301, 483-487). However, all of these approaches are very limited in the complexity of structures, including material properties, such as rigidity, conductivity, reactivity, and permeability, which can be generated, especially at sub-millimeter length scales. Moreover, very long time scales of many hours or days are typically required for a collection of designed components (e.g. DNA and nanoparticles) in a liquid material to randomly diffuse, join together in the proper relative arrangement and orientation through attractive interactions, and form a desired assembly.

For example, short single-stranded DNA that have pre-designed complementary base sequences that can create desired attractive interactions, which are mixed together in a liquid material at an appropriate temperature, must randomly diffuse into close spatial proximity and to diffusively re-orient before short-range selective attractive forces play a role and cause the pieces to form an assembly that does not come apart subsequently under thermal or other agitation. This process of diffusion is inherently slow; the probability rate of the proper DNA strands diffusing into positions and orientations close enough to other DNA strands for the desired attractions to occur without significant errors being introduced is typically so low that it takes many hours to many days for the desired structures to be self-assembled. Often, this is accompanied by temperature changes that alter the strength of the interactions between strands of DNA progressively from weaker to stronger. This low rate of random self-assembly is generally not desirable and can lead to a significant rate of defects, so a faster method of production that does not rely only upon random diffusion would provide a considerable advantage. Therefore, due to limitations in the current art, there is considerable improvement that could be made in processes and compositions of fabricating particles that have internal particle sub-structures that can be reconfigured to yield a desired shape or range of shapes using a top-down method that is amenable to parallel mass-production with low defects and offers a simplified lithographic procedure, thereby reducing cost and time of production.

Among methods of producing shape-designed particles, which typically have sub-millimeter maximum spatial dimensions, the methods of spatially patterned radiation (U.S. patent application Ser. No. 12/377,773 which claims priority to PCT/US07/18365 and 60/838,160 all of which are incorporated herein by reference), the method of relief deposition templating (U.S. patent application Ser. No. 12/563,907 which claims priority to PCT/US08/003,679, 61/100,471 and 60/918,896 all of which are incorporated herein by reference) are among the best suited for mass-producing such particles. In particular, the method of relief deposition templating can provide large numbers of particles without a need for repeated lithographic exposure after the template has been produced. Other methods for producing shape-designed particles are relief radiation templating (U.S. patent application Ser. No. 12/575,920 which claims priority to 61/103,777 both of which are incorporated herein by reference) and two-patterned surface imprinting (U.S. patent application Ser. No. 12/579,226 which claims priority to 61/105,232 both of which are incorporated herein by reference). Since in some cases, it is desirable to produce particles that have the capability of being able to reconfigure internally through at least one of a relative repositioning and reorienting of sub-structures, thereby providing a mechanism for additional useful functionality, there still remain opportunities for creating particles that have structures and functionalities that extend beyond the current art.

For the purposes of this specification, we refer to a particle having a customized shape or range of shapes, customized size or range of sizes, and/or customized composition as a custom-shaped particle or a complex-shaped particle. In some of the above-noted references, lithographic particles, also referred to as LithoParticles, can provide examples of custom-shaped particles according to some embodiments of the current invention. For the purposes of this specification, we refer to a lithomer to be a component sub-structure of a particle that typically involves a lithographic method in its production. For the purposes of this specification, we refer to a lithomeric particle as a custom-shaped particle that contains one or more lithomers (i.e. sub-structures).

### SUMMARY

A method of producing a particle according to some embodiments of the current invention includes fabricating a precursor particle structure that has a first sub-structure, a second sub-structure proximate the first sub-structure and an interconnecting sub-structure connected to the first and second sub-structures, the precursor particle structure being in a first configuration; and exposing the precursor particle structure to a stochastic excitation process to cause a deformation of the interconnecting sub-structure to reconfigure at least one of a position and an orientation of the first sub-structure relative to the second sub-structure from the first configuration to form the particle in a second configuration. The first sub-structure and the second sub-structure are substantially free of deformation during the exposing, and a maximal spatial dimension of the particle in the second configuration is less than about one millimeter.

A multi-component composition according to some embodiments of the current invention has a first material component, and a plurality of particles produced according to methods of the current invention that are dispersed in the first material component. A maximal spatial dimension of each of the plurality of particles is less than about 10 micrometers, and the plurality of particles is at least 10 particles.

### BRIEF DESCRIPTION OF THE DRAWINGS

The invention is better understood by reading the following detailed description with reference to the accompanying figures in which:

FIG. 1A is a schematic side-view illustration of a portion of the upper surface of a substrate material (dark layer) that has a flat and smooth surface suitable for deposition of other materials, according to an embodiment of the current invention.

FIG. 1B is a schematic side-view illustration of a release material (upper dash-patterned layer) that has been deposited as a uniform layer onto the upper surface of the substrate material (dark layer), shown in FIG. 1A, according to an embodiment of the current invention.

FIG. 1C is a schematic side-view illustration of a particle material (upper square-patterned layer), such as uncrosslinked photoresist, that has been deposited as a uniform layer onto the substrate material (dark layer) that has been previously coated with release material (dash-patterned layer between the square patterned layer and dark layer), shown in FIG. 1B, according to an embodiment of the current invention.

FIG. 1D is a schematic side-view illustration of particle material (upper layer) that has been spatially patterned, typically by exposure to spatially patterned radiation, in a manner that causes a portion of the particle material to transform into a modified particle material (darker dot-patterned portion of the upper layer) to form at least a particle sub-structure, according to an embodiment of the current invention. Unmodified particle material (lighter square patterned portion of the upper layer) remains. As examples, two sets of three blocks of modified particle material that are interconnected at their bases by a thin layer of modified particle material are shown at the upper region of the schematic illustration. According to an embodiment of the current invention, an example of a process that can cause such spatial patterning of the particle material is a lithographic exposure of a radiation-sensitive particle material that contains a photoresist using a stepper lithography system.

FIG. 1E is a schematic side-view illustration of modified particle material that is attached to a release material on a substrate material, subsequent to the removal of unmodified particle material (e.g. by a process such as development of an exposed photoresist using a liquid solvent), according to an embodiment of the current invention. As shown, the remaining particle material consists of two sets of three solid blocks, wherein each set of three solid blocks is connected by a thin layer of a deformable particle material.

FIG. 1F is a schematic side-view illustration of the liberation of the spatially patterned particle material shown in FIG. 1E from the substrate material by the removal of the release material by a fluid material (cross-hatched region above the lower dark layer), according to an embodiment of the current invention. According to an embodiment of the current invention, immediately after liberation from the substrate material, within each particle, the spatially patterned blocks of particle material have an initial linear internal configuration that is not the desired final triangular internal configuration.

FIG. 1G is a schematic side-view illustration of the final states of liberated particles of particle material, consisting of three blocks interconnected by a thin deformable film in a triangular internal configuration, after the blocks have internally reconfigured due to energetic excitations that have sufficient energy to cause the thin deformable film of particle material to deform, thereby enabling the desired final internal configuration of the particle to be reached, while dispersed in a fluid material (cross-hatched region) and separated from the substrate material, according to an embodiment of the current invention.

FIG. 2A is a schematic side-view illustration of a portion of a substrate material (dark lower layer), upon which a layer of release material (dash-patterned layer above dark lower layer) has been deposited, upon which a layer of a first flexible particle material (horizontal-line patterned layer above dash-patterned layer) has been deposited, upon which a layer of a second rigid particle material (square-patterned layer above the horizontal-line patterned layer) has been deposited, according to an embodiment of the current invention.

FIG. 2B is a schematic side-view illustration of the layers shown and described in FIG. 2A after the second rigid particle material has been spatially patterned (e.g. using a lithographic method to cause a change such as crosslinking of a polymer resin in a portion of the first and second particle materials), according to an embodiment of the current invention. The spatial patterning has been designed to create a plurality of discrete particles containing particle sub-structures that consist of regions of the second rigid particle material (dark dot-patterned regions), which are interconnected by the first flexible particle material (horizontal-line patterned layer). According to an embodiment of the current invention, the structures (e.g. polymers) within the first flexible particle material are long enough to span the smaller distances between sub-structures of the second particle material within the particles but not the larger distances between separate discrete particles.

FIG. 2C is a schematic side-view illustration according to an embodiment of the current invention of first and second particle materials (dot-patterned slab-like regions and horizontal-patterned regions, respectively) after spatially patterning and a development process that removes a portion of the first and second particle materials, thereby creating discrete particles that have sub-structures of particle materials. The discrete particles remain attached to the release material (dash-patterned layer) and substrate (dark lower layer).

FIG. 2D is a schematic side-view illustration showing the release of two discrete particles, each containing three sub-structures of the second rigid particle material that are interconnected by the first flexible particle material, subsequent to the removal of the release material and dispersal in a fluid material (cross-hatched region) above the substrate material (dark lower layer), according to an embodiment of the current invention. For example, the fluid material can simply dissolve the release layer. As shown the initial configuration of sub-structures within the particles immediately after release is not the desired final configuration of sub-structures.

FIG. 2E is a schematic side-view illustration showing two discrete particles that have sub-structures which have reconfigured as a result of energetic excitations in the fluid material (cross-hatched region) into a desired triangular internal configuration of sub-structures of the second rigid particle material accompanied by deformation of the first flexible particle material that interconnects the sub-structures, according to an embodiment of the current invention. For example, the energetic excitations could be thermal stochastic excitations.

FIG. 3A is a schematic side-view illustration of a patterned solid substrate that has been designed and fabricated to facilitate the production of a plurality of discrete particles that have sub-structures that can reconfigure using a method of well-deposition templating, according to an embodiment of the current invention. As shown, the patterned solid substrate has an array of discrete and complex well-like relief structures below a flat surface.

FIG. 3B is a schematic side-view illustration of the patterned solid substrate from FIG. 3A upon which a layer of a release material (diagonal-stripe patterned layer) has been deposited, according to an embodiment of the current invention. For example, a spray deposition that is multi-directional could produce the layer of release material shown.

FIG. 3C is a schematic side-view illustration of a first particle material (dash-patterned regions) that has been deposited onto the substrate that has been coated with release material from FIG. 3B, according to an embodiment of the current invention. For example, a vertical directional deposition of particle material could be used to fill the deeper well-like structures with the first particle material while leaving portions of the release material exposed, thereby facilitating subsequent release of deposited particle material. Typically, the first particle material

FIG. 3D is a schematic side-view illustration of a second particle material (checker-patterned regions) that has been deposited onto the first particle material of FIG. 3C, according to an embodiment of the current invention. Typically, the material properties and thickness of the second particle material are chosen so that the second particle material can be deformed significantly by energetic excitations. In addition, typically, the second particle material interconnects at least some regions of the first particle material that were not interconnected after the deposition of the first particle material.

FIG. 3E is a schematic side-view illustration of initial states of two example particles from among the plurality of particles that have been released from the substrate material by removing (e.g. dissolving) the release material using a fluid material (cross-hatched region), according to an embodiment of the current invention. The initial state of each example particle consists of three linear sub-structures of the first particle material (i.e. triangular wedges) that are interconnected by the second particle material (i.e. a thin layer of checker-patterned region).

FIG. 3F is a schematic side-view illustration of final states of two example particles in a fluid material (as described in FIG. 3E) after energetic excitations have cause deformation of the second particle material, enabling the reconfiguration of the particle sub-structures of the first material from the initial state into a desired triangular configuration, according to an embodiment of the current invention. In some cases, attractive interactions between one region of the second particle material and another region of the second particle material within the same particle can be introduced to fix the final state and inhibit further internal reconfiguration of particle sub-structures.

FIG. 4A is a schematic top-view illustration of a portion of an optical lithography mask pattern that is suitable for spatially patterning a particle material using an optical lithography system in order to create a plurality of discrete particles that have reconfigurable sub-structures of a particle material, according to an embodiment of the current invention. The light regions permit the transmission of the light and the dark regions block the transmission of light. As shown, there are six sets of four triangles that have been designed in an arrangement that are useful for producing six discrete particles each of which contains four triangular sub-structures whose edges are separated by a smaller spacing that is significantly less than the larger spacing between the edges of the discrete particles. For example, a mask pattern can be designed and written to create a layer of patterned chrome on quartz that is suitable for use as a reticle mask in a stepper lithography system.

FIG. 4B is a schematic top-view illustration of a particle that has been fabricated in an initial pseudo-planar state using the mask pattern of FIG. 4A, according to an embodiment of the current invention. Four triangles of a first particle material (solid triangular regions) are sub-structures of the particle, and these four sub-structures are interconnected by a second particle material (diagonal-striped region). The particle sub-structures are parallel with a reference plane (e.g. a flat smooth substrate). Typically, the triangular particle sub-structures made of the first particle material are more rigid than the interconnecting structure of the second particle material that interconnects them.

FIG. 4C is a schematic ortho-view illustration of a particle that has undergone internal reconfiguration of its sub-structures due to energetic excitations from an initial pseudo-planar state of FIG. 4B into a state that is a fully three-dimensional tetrahedral shape, according to an embodiment of the current invention. Typically, the energetic excitations cause a deformation of the second particle material (diagonal striped region) that interconnects the sub-structures of the first particle material (solid triangular regions). In addition, typically, attractive interactions between particle sub-structures overcome the energetic excitations and cause binding of sub-structures of the first particle material, thereby inhibiting at least some degrees of freedom of internal reconfigurations of attractively bound particle sub-structures. As shown, three solid lines along the edges of the tetrahedron show regions where attractive interactions between the particle sub-structures cause binding between them.

FIG. 5A is a schematic top-view illustration of a portion of an optical lithography mask pattern that is suitable for spatially patterning a particle material using an optical lithography system in order to create a plurality of discrete particles that have reconfigurable sub-structures of a particle material, according to an embodiment of the current invention. The light regions permit the transmission of the light and the dark regions block the transmission of light. As shown, there are six sets of four triangles that have been designed in an arrangement that are useful for producing six discrete particles each of which contains four triangular sub-structures whose edges are separated by a smaller spacing that is significantly less than the larger spacing between the edges of the discrete particles but that are also interconnected by three pairs of very narrow transmitting (i.e. light) strips. For example, a mask pattern can be designed and written to create a layer of patterned chrome on quartz that is suitable for use as a reticle mask in a stepper lithography system.

FIG. 5B is a schematic top-view illustration of a particle that has been fabricated in an initial pseudo-planar state using the mask pattern of FIG. 5A, according to an embodiment of the current invention. Four triangles of a particle material (solid regions) are sub-structures of the particle, and these four triangular sub-structures are interconnected by three pairs of very narrow strips of the same particle material. The particle sub-structures are parallel with a reference plane (e.g. a flat smooth substrate). Typically, the triangular particle sub-structures made of the particle material are more rigid and deform less than the very narrow strips of particle material that interconnects the triangular sub-structures. For example, the dimensions of the very narrow strips of the particle material are chosen to enable those very narrow strips to deform significantly, yet not enable the larger triangular regions of the particle material to deform significantly, under anticipated energetic excitations to be applied subsequent to fabrication of the shown pseudo-planar state.

FIG. 5C is a schematic ortho-view illustration of a particle that has undergone internal reconfiguration of its sub-structures due to energetic excitations from an initial pseudo-planar state of FIG. 5B into a state that is a fully three-dimensional tetrahedral shape, according to an embodiment of the current invention. Typically, the energetic excitations cause a deformation of the pairs of very thin strips of particle material that interconnect the triangular sub-structures of the particle material. In addition, typically, attractive interactions between particle sub-structures overcome the energetic excitations and cause binding of sub-structures of the particle material, thereby inhibiting at least some degrees of freedom of internal reconfigurations of attractively bound particle sub-structures. As shown, solid lines along the edges of the tetrahedron show regions where attractive interactions between the particle sub-structures cause binding between them.

FIG. 6A is a schematic top-view illustration of a portion of an optical lithography mask pattern that is suitable for spatially patterning a particle material using an optical lithography system in order to create a plurality of discrete particles that have reconfigurable sub-structures of a particle material, according to an embodiment of the current invention. The light regions permit the transmission of the light and the dark regions block the transmission of light. As shown, there are six sets of four triangles that have been designed in an arrangement that are useful for producing six discrete particles each of which contains four triangular sub-structures whose edges are separated by a smaller spacing that is significantly less than the larger spacing between the edges of the discrete particles but that are also interconnected by three pairs of very narrow transmitting (i.e. light) strips. For example, a mask pattern can be designed and written to create a layer of patterned chrome on quartz that is suitable for use as a reticle mask in a stepper lithography system.

FIG. 6B is a schematic top-view illustration of a particle that has been fabricated in an initial pseudo-planar state using the mask pattern of FIG. 6A, according to an embodiment of the current invention. Four triangles of a first particle material (solid regions) are sub-structures of the particle, and these four triangular sub-structures are interconnected by a combination of three pairs of very narrow strips of the same first particle material and also a second particle material (striped region) that extends beyond the edges of the triangular sub-structures. The particle sub-structures are parallel with a reference plane (e.g. a flat smooth substrate). Typically, the triangular particle sub-structures made of the first particle material are more rigid and deform less than the combination of first and second materials that interconnect them. For example, the dimensions of the very narrow strips of the first particle material and the thickness of the second particle material are chosen to enable the combination of interconnecting materials to deform significantly, yet not enable the larger triangular regions of the first particle material to deform significantly, under anticipated energetic excitations to be applied subsequent to fabrication of the shown pseudo-planar state.

FIG. 6C is a schematic ortho-view illustration of a particle that has undergone internal reconfiguration of its sub-structures due to energetic excitations from an initial pseudo-planar state of FIG. 6B into a state that is a fully three-dimensional tetrahedral shape, according to an embodiment of the current invention. Typically, the energetic excitations cause a deformation of the combination of the pairs of very thin strips of the first particle material and the second particle material that interconnect the triangular sub-structures of the first particle material. In addition, typically, attractive interactions between regions of the second particle material overcome the energetic excitations and cause binding of sub-structures of the particle material, thereby inhibiting at least some degrees of freedom of internal reconfigurations of attractively bound particle sub-structures. As shown, solid lines along the edges of the tetrahedron show regions where attractive interactions between the particle sub-structures cause binding between them.

FIG. 7A is a schematic top-down illustration of a particle that has been fabricated in an initial pseudo-planar state using the mask pattern of FIG. 4A, according to an embodiment of the current invention. Four triangles of a first particle material (solid regions) are sub-structures of the particle, and these four triangular sub-structures are interconnected by a second particle material (striped region) that extends beyond the edges of the triangular sub-structures. The particle sub-structures are parallel with a reference plane (e.g. a flat smooth substrate). Typically, the triangular particle sub-structures made of the first particle material are more rigid than the interconnecting structure of the second particle material.

FIG. 7B is a schematic side-view illustration of the pseudo-planar state of the particle shown in FIG. 7A, according to an embodiment of the current invention. As shown, the interconnecting film of the second particle material (lower striped region) forms a thin layer below the four discrete triangular sub-structures of the first particle material (upper solid regions) that interconnects these triangular sub-structures.

FIG. 7C is a schematic ortho-view illustration of a particle that has undergone internal reconfiguration of its sub-structures due to energetic excitations from an initial pseudo-planar state of FIGS. 7A and 7B into a state that is a fully three-dimensional tetrahedral shape, according to an embodiment of the current invention. Typically, the energetic excitations cause deformations of the thin film interconnecting structure of the second particle material (striped regions) that interconnects the triangular sub-structures of the first particle material (solid regions). In addition, typically, attractive interactions between regions of the second particle material overcome the energetic excitations and cause binding of sub-structures of the first particle material, thereby inhibiting at least some degrees of freedom of internal reconfigurations of attractively bound particle sub-structures. As shown, the striped regions along the edges of the tetrahedron show regions where attractive interactions between the particle sub-structures cause binding between them.

FIG. 8A is a schematic top-down illustration of a particle that has been fabricated in an initial pseudo-planar state using the mask pattern of FIG. 4A, according to an embodiment of the current invention. Four triangles of a first particle material (solid regions) are sub-structures of the particle, and these four triangular sub-structures are interconnected by a second particle material (dash-patterned region). A third particle material (striped patterned region) is attached to the first particle material at the extremities that extends beyond the edges of the triangular sub-structures. The particle sub-structures are parallel with a reference plane (e.g. a flat smooth substrate). Typically, the triangular particle sub-structures of the first particle material are more rigid than the interconnecting structure of the second particle material. According to an embodiment of the current invention, only the attractive interactions between one region of the third particle material and another region of the third particle material provide a sufficiently large attraction to cause binding between the two regions in the presence of energetic excitations.

FIG. 8B is a schematic side-view illustration of the pseudo-planar state of the particle shown in FIG. 8A, according to an embodiment of the current invention. As shown, the interconnecting film of the second particle material (lower dash-patterned region) forms a thin layer below the four discrete triangular sub-structures of the first particle material (upper solid regions). The third particle material (lower striped-patterned regions) extends beyond the edges of the three non-central triangular sub-structures of the first particle material.

FIG. 8C is a schematic ortho-view illustration of a particle that has undergone internal reconfiguration of its sub-structures due to energetic excitations from an initial pseudo-planar state of FIGS. 8A and 8B into a state that is a fully three-dimensional tetrahedral shape, according to an embodiment of the current invention. Typically, energetic excitations cause deformations of the thin film interconnecting structure of the second particle material (dashed-patterned regions) that interconnects the triangular sub-structures of the first particle material (solid regions). In addition, typically, attractive interactions between different regions of the third particle material (stripe-patterned regions) cause binding of particle sub-structures into a desired configuration, thereby overcoming subsequent energetic excitations and inhibiting at least some degrees of freedom of internal reconfigurations of attractively bound particle sub-structures. As shown, the third particle material along the edges of the tetrahedron show regions where attractive interactions between the third particle material have caused binding that enables the particle to persist in the form of a tetrahedral shape, even in the presence of continuing energetic excitations.

FIG. 9A is a schematic top-view illustration of a particle that has been fabricated to have six square sub-structures of a first particle material (solid regions), a second particle material (stripe-patterned regions), and a third particle material (granular-patterned regions), according to an embodiment of the current invention. The particle is in an initial pseudo-planar state.

FIG. 9B is a schematic side-view illustration of the particle shown in FIG. 9A, according to an embodiment of the current invention.

FIG. 9C is a schematic ortho-view illustration of the particle shown in FIGS. 9A and 9B that has reconfigured into a three-dimensional cube, subsequent to energetic excitations that have caused internal reconfigurations of particle sub-structures of the first particle material (solid regions) by deforming the second particle material (stripe-patterned regions) and facilitating binding of different regions of the third particle material (granular patterned regions) with itself, according to an embodiment of the current invention. Typically, the binding of the third particle material with itself is sufficiently strong to overcome energetic excitations, so that the configuration of the cube persists.

FIG. 10A is a schematic top-view illustration of a particle that has been fabricated in a pseudo-planar state, consisting of two sets of six pentagonal regions of a first particle material (solid regions) interconnected by a second particle material (stripe-patterned regions), according to an embodiment of the current invention. A third particle material (granular-patterned regions) extends beyond the edges of the first particle material. Typically, the sub-structures of the first particle material are more rigid than the sub-structures of the second particle material, and the third particle material has a propensity to attractively bind with itself.

FIG. 10B is a schematic ortho-view illustration of the particle in FIG. 10A that has reconfigured into a three-dimensional dodecahedron, subsequent to energetic excitations that have caused internal reconfigurations of particle sub-structures of the first particle material (solid regions) by deforming the second particle material (stripe-patterned regions) and facilitating binding of different regions of the third particle material (granular patterned regions) with itself, according to an embodiment of the current invention. Typically, the binding of the third particle material with itself is sufficiently strong to overcome energetic excitations, so that the configuration of the dodecahedron persists.

FIG. 11A is a schematic top-view illustration of a particle that has been fabricated to have six square platelet sub-structures of a first particle material (solid regions) that are interconnected by a thin film of a second particle material (diagonal stripe-patterned regions) and have a first binding material (vertical stripe-patterned region at the top) and a second binding material (granular-patterned region at the bottom), where the particle sub-structures are in a pseudo-planar state, according to an embodiment of the current invention. Typically, attractive interactions are only strong, compared to energetic excitations, between the first binding material and the second binding material.

FIG. 11B is a schematic ortho-view illustration of the particle of FIG. 11A, subsequent to energetic excitations that have caused deformation of the second particle material, reconfiguration of sub-structures of the first particle material, thereby facilitating binding of the first binding material with the second binding material, so that the reconfigured sub-structures of the first particle material form an open hexagonal ring of squares, according to an embodiment of the current invention.

FIG. 12A is a schematic side-view illustration of a particle that has been fabricated to have three square platelet sub-structures of a first particle material (solid regions) that are interconnected by a two thin films of a second particle material (dot-patterned regions), and have a third particle material (stripe-patterned regions) at the outer two edges, where particle sub-structures are in a pseudo-planar state, according to an embodiment of the current invention. Only attractive interactions between one region of the third particle material and another region of third particle material are sufficiently strong to overcome energetic excitations and cause attractive binding between these regions of third particle material that persists. The interactions between other types of particle materials are either hard or repulsive, so that no permanent binding can occur that involves regions of the first or second particle materials.

FIG. 12B is a schematic illustration of an unbound, non-pseudo-planar state of the particle of FIG. 12A, subsequent to energetic excitations that have caused a reconfiguration of particle sub-structures of the first particle material through deformation of the second particle material, according to an embodiment of the current invention. In the configuration shown, the regions of third particle material remain separated from each other, and hard or repulsive interactions between the first particle material with itself provide a steric barrier that inhibits the attractive regions of the third particle material from becoming proximate through further bending of the second particle material in the direction away from the initial pseudo-planar state, so no binding of the separated regions of third particle material can occur in this configuration. Continuing energetic excitations can cause additional reconfigurations by deforming the second particle material in a manner that is allowed by the hard or repulsive interactions between the first particle material.

FIG. 12C is a schematic side-view illustration of a non-pseudo-planar bound state of the particle of FIG. 12A, subsequent to energetic excitations that have caused reconfiguration of particle sub-structures of the first particle material (solid regions) through deformation of the second particle material (dot-patterned regions), which have enabled the separate regions of third particle material (stripe-patterned regions) to become proximate and attractively bind with a binding energy that is larger than the energy of the energetic excitations, according to an embodiment of the current invention. Although the hard or repulsive interactions of the first particle material with itself have sterically inhibited some potential states of reconfiguration of the sub-structures of the first particle material, other potential states of reconfiguration can be explored as energetic excitations continue, thereby enabling regions of the third particle material to become proximate and bind in the configuration shown.

FIG. 13A is a schematic top-view illustration of an initial unbound state of a particle that has been fabricated to have a central hexagonal platelet and six triangular platelets of a first particle material (solid regions) that are interconnected by circular regions of a second particle material (stripe-patterned regions), where circular regions of a third particle material (dash-patterned regions) are attached to certain vertices of the triangles, according to an embodiment of the current invention. Typically, the first and second particle materials cannot attractively bind with the same or other particle materials, yet one region of the third particle material can bind with another region of third particle material if those regions were to become spatially proximate. As shown, the particle has been designed and fabricated to provide more than one possible bound state subsequent to the application of energetic excitations.

FIG. 13B is a schematic top-view illustration of a first possible bound state of the particle shown in FIG. 13A, subsequent to energetic excitations causing deformation of the second particle material, reconfiguration of sub-structures of the first particle material, and attractive binding of the third particle material, according to an embodiment of the current invention.

FIG. 13C is a schematic top-view illustration of a second possible bound state of the particle shown in FIG. 13A, subsequent to energetic excitations causing deformation of the second particle material (stripe-patterned regions), reconfiguration of sub-structures of the first particle material (solid regions), and attractive binding of the third particle material (dash-patterned regions), according to an embodiment of the current invention.

FIG. 14A is a schematic top-view illustration of an initial unbound state of a particle that has been fabricated to have a central hexagonal platelet and six triangular platelets of a first particle material (solid regions) that are interconnected by circular regions of a second particle material (stripe-patterned regions), where circular regions of a third particle material (dash-patterned regions) are attached to certain vertices of the triangles, according to an embodiment of the current invention. Typically, the first and second particle materials cannot attractively bind with the same or other particle materials, yet one region of the third particle material can bind with another region of third particle material if those regions were to become spatially proximate. As shown, the particle has been designed and fabricated to selectively facilitate binding between three pairs of neighboring triangles, subsequent to the application of energetic excitations.

FIG. 14B is a schematic top-view illustration of a desired bound state of three pairs of triangular particle sub-structures of the particle shown in FIG. 14A, subsequent to energetic excitations causing deformation of the second particle material (stripe-patterned regions), reconfiguration of sub-structures of the first particle material (solid regions), and attractive binding of the third particle material (dash-patterned regions), according to an embodiment of the current invention.

FIG. 15 is a transmission optical micrograph of a particle (and a portion of another particle) showing sub-structures of a polymeric material (crosslinked SU-8 photoresist) interconnected by a thin film of polymeric material (crosslinked SU-8 photoresist) in a pseudo-planar configuration, subsequent to being released from a substrate material into an aqueous fluid material, according to an embodiment of the current invention. Each of the sub-structures has an edge length of 4.5 microns and a thickness of 1.0 micron. The thickness of the thin film that interconnects the sub-structures is estimated to be less than about 100 nm.

FIG. 16A is a transmission optical micrograph of a particle showing a first and a second square-frame sub-structures of a polymeric material (crosslinked SU-8 photoresist) interconnected by a thin film of polymeric material (crosslinked SU-8 photoresist) in a pseudo-planar initial configuration, subsequent to being released from a substrate material into an aqueous fluid material, according to an embodiment of the current invention. Each of the square-frame sub-structures has an edge length of 4.5 microns and a thickness of 1.0 micron. The thickness of the thin film that interconnects the square-frame sub-structures is estimated to be less than about 100 nm.

FIG. 16B is a transmission optical micrograph of a particle showing two square-frame sub-structures of a polymeric material (crosslinked SU-8 photoresist) interconnected by a thin film of polymeric material (crosslinked SU-8 photoresist) in a first non-initial configuration, subsequent to being released from a substrate material into an aqueous fluid material and the application of stochastic entropic and ultrasonic excitations, according to an embodiment of the current invention. The interconnecting sub-structure has deformed as a result of the excitations, causing a reconfiguration of the two square-frame sub-structures. Each of the square-frame sub-structures has an edge length of 4.5 microns and a thickness of 1.0 micron. The thickness of the thin film that interconnects the square-frame sub-structures is estimated to be less than about 100 nm.

FIG. 16C is a transmission optical micrograph of a particle showing a first and a second square-frame sub-structure of a polymeric material (crosslinked SU-8 photoresist) interconnected by a thin film of polymeric material (crosslinked SU-8 photoresist) in a second non-initial configuration, subsequent to being released from a substrate material into an aqueous fluid material and the application of stochastic entropic and ultrasonic excitations, according to an embodiment of the current invention. The interconnecting sub-structure has deformed as a result of the excitations, causing a reconfiguration of the first and second square-frame sub-structures. A strain associated with a deformation of the interconnecting sub-structure exceeds 1%. A change in a relative orientational angle between the first and second square-frame sub-structures, as compared to those in the initial configuration shown in FIG. 16A, exceeds one degree. A change in the distance between the center of mass of the first square-frame sub-structure relative to the center of mass of the second square-frame sub-structure exceeds one nanometer. Each of the square-frame sub-structures has an edge length of 4.5 microns and a thickness of 1.0 micron. The thickness of the thin film that interconnects the square-frame sub-structures is estimated to be less than about 100 nm.

FIG. 16D is a transmission optical micrograph of a particle showing a first square-frame sub-structure and a second square-frame sub-structure of a polymeric material (crosslinked SU-8 photoresist) interconnected by a thin film of polymeric material (crosslinked SU-8 photoresist) in a third non-initial configuration, subsequent to being released from a substrate material into an aqueous fluid material and the application of stochastic excitations, according to an embodiment of the current invention. The interconnecting sub-structure has deformed as a result of the excitations, causing a reconfiguration of the first and second square-frame sub-structures. A strain associated with a deformation of the interconnecting sub-structure exceeds 1%. A change in a relative orientational angle between the first and second square-frame sub-structures, as compared to those in the initial configuration shown in FIG. 16A, exceeds one degree. A change in the distance between the center of mass of the first square-frame sub-structure relative to the center of mass of the second square-frame sub-structure exceeds one nanometer. Each of the square-frame sub-structures has an edge length of 4.5 microns and a thickness of 1.0 micron. The thickness of the thin film that interconnects the square-frame sub-structures is estimated to be less than about 100 nm.

FIG. 17A is a transmission optical micrograph of a particle showing three square-frame sub-structures of a polymeric material (crosslinked SU-8 photoresist) interconnected by two thin films of polymeric material (crosslinked SU-8 photoresist) in a first linear quasi-planar initial configuration, subsequent to being released from a substrate material into an aqueous fluid material, according to an embodiment of the current invention. Each of the square-frame sub-structures has an edge length of 4.5 microns and a thickness of 1.0 micron. The thickness of the thin film that interconnects the square-frame sub-structures is estimated to be less than about 100 nm.

FIG. 17A is a transmission optical micrograph of a particle showing three square-frame sub-structures of a polymeric material (crosslinked SU-8 photoresist) interconnected by two thin films of polymeric material (crosslinked SU-8 photoresist) in a second branched quasi-planar initial configuration, subsequent to being released from a substrate material into an aqueous fluid material, according to an embodiment of the current invention. Each of the square-frame sub-structures has an edge length of 4.5 microns and a thickness of 1.0 micron. The thickness of the thin film that interconnects the square-frame sub-structures is estimated to be less than about 100 nm.

### DETAILED DESCRIPTION

In describing embodiments of the present invention illustrated in the drawings, specific terminology is employed for the sake of clarity. However, the invention is not intended to be limited to the specific terminology so selected. It is to be understood that each specific element includes all technical equivalents which operate in a similar manner to accomplish a similar purpose.

Given the inherent slowness of entirely diffusion-driven self-assembly approaches for making complex custom-shaped particles dispersed in a fluid material, in order to reduce defect rates and to speed up the process of forming desirable custom-shaped particles in a fluid material, it is advantageous to fabricate a set of particle sub-structures, at least some of which are rigid that are proximate to each other and properly oriented so that, when enabled to move and when moved by appropriate energetic agitation, said particle sub-structures restructure to form a desired particle shape or range of particle shapes. Furthermore, it could be highly advantageous for these particle sub-structures to be pre-connected, at least to some degree, by one or more interconnecting sub-structures in a manner that speeds up the rate of change of shape and binding of proximate sub-structures through attractive interactions, to form a final desired complex composite structure (i.e. custom-shaped particle) composed of rigid and flexible sub-structures over time scales that are rapid and practical. In addition, it would be desirable to pre-design and fabricate the shape, size, and pre-configuration of particle sub-structures that make up a particle on a solid substrate material to facilitate mass-production at colloidal length scales using top-down lithographic methods and then release said particles from said substrate material into a fluid material so that said particle sub-structures can reconfigure due to energetic excitations.

Some embodiments of the current invention include a process, and materials produced from that process, based on forming complex-shaped particles at the sub-millimeter scale through a combination of lithographic prefabrication of sub-structural components (i.e. sub-structures) connected to a substrate, and subsequent agitation of those sub-structures to cause them to move in a manner that can rapidly provide desired attachments between the sub-structures in a new desired configuration with low error rates. A portion of lithographic sub-structures, or “lithomers”, typically possess significant rigidity, are typically fabricated lithographically on a substrate or template, pre-arranged in close relative proximity, and, in some cases, pre-connected to other sub-structures within the same complex-shaped particle using a flexible material and/or a bonding material. Sub-structures can be created using a variety of lithographic means, including but not limited to patterning, exposure, development, stamping, deposition, and/or templating methods. Release (i.e. disconnection) of at a least a portion of the sub-structures from the substrate or template enables these sub-structures to reconfigure under agitation, typically in a fluid material. Re-configuration of the sub-structures is accomplished through energetic excitations, typically mediated by the fluid material, which can include simple entropic thermal agitation that causes Brownian motion and/or externally applied sources of agitation. A desired configuration is locked in place using attractive interactions of portions of the sub-structures that are geometrically permitted to interact as a result of the agitation, relative placement of the sub-structures, and any pre-designed flexible interconnections between sub-structures. The close relative proximity and alignment of sub-structural components that have been fabricated, interconnected by flexible interconnecting sub-structures, and released into the fluid material creates a dramatic decrease in the time required to form desired assemblies at low defect rates. According to an embodiment of the current invention, a plurality of these complex-shaped particles can be at least partially separated from the lithographic substrate. According to an embodiment of the invention, interconnecting sub-structures are manufactured lithographically. According to other embodiments of the current invention, interconnecting sub-structures are created by at least one of a coating process, an adsorption process, a stamping process, an imprinting process, and a deposition processes.

According to an embodiment of the current invention, a shape-designed complex-shaped composite particle is fabricated to have a plurality of interconnected sub-structures, also called lithomers. Thus, such a particle could equivalently be referred to as a “poly-lithomer”, a “poly-lithomeric object”, a “poly-lithomeric particle”, or simply a “lithomeric particle”. In essence, a lithomer is a lithographic sub-structure that is a building block or portion of a complex-shaped particle. Just as polymers are composed of interconnected molecular monomers that can have a variety of chemical compositions, structures, and functionalities, lithomeric particles are composed of interconnected lithomers that can have different chemical compositions, shapes, sizes, structures, functionalities, and physical properties. The difference between a lithomeric particle and a self-assembled particle is that rigid building block sub-structures in a lithomeric particle are typically pre-configured and pre-connected by flexible, deformable sub-structures that effectively limit the range of possibilities of reconfiguration of the lithomers in a desired manner. By contrast a self-assembled particle (e.g. a virus shell made of proteins or a DNA origami made of DNA oligomers) must rely upon diffusion of the building blocks and partially completed assemblies until they approach one another in relative positions and orientations that enables bonding into a complex shape, and this diffusion-driven random searching process involved in making self-assemblies in a fluid material is typically very slow.

### A First Example Embodiment of the Current Invention

A simple example embodiment of the process for creating desired complex-shaped particles using the approach of stochastic agitation of pre-configured lithographic sub-structures is as follows. This embodiment utilizes spin-coating as a deposition method, spatially patterned radiation based on a pre-designed mask as the patterning method, a radiation-sensitive material that can be made resistant to development and is rigid as a rigid sub-structure material, and stochastic thermal fluctuations (i.e. thermal energy), mediated by the fluid material, as the source of energetic excitations of the sub-structures subsequent to release from a substrate.

Step #1: Design and fabricate a mask pattern containing a plurality of sets of pre-configured sub-structures that can form a plurality of particles, wherein, for each particle, said pre-configured sub-structures are in close relative proximity and alignment, providing a close approximation of a portion of the desired position and alignments of sub-structures in the final desired object. Typically, the gaps between sub-structures within a given particle are smaller than the gaps between neighboring particles. This pre-designed difference in gap distances typically facilitates the creation of desirable interconnections between sub-structures within the same particle, while at the same time inhibiting the creation of undesirable interconnections between sub-structures of neighboring particles that are intended to remain discrete. An example of a practical implementation of this step is as follows: A mask pattern of a plurality pre-configured positioned and aligned sub-structures that can form a plurality of desired objects (with appropriate differences in gap spacings between neighboring sub-structures within a particle and separate particles) are created using suitable mask design software, such as L-Edit software by Tanner. The generated computer file containing the desired mask patterns is transferred to a mask-writing device, such as a MEBES electron-beam writing system, that can fabricate a chrome-quartz mask that is suitable for use in an optical lithographic exposure system, such as an Ultratech XLS i-line stepper. An example mask pattern consists of a regular repeating pattern to create a plurality of objects, wherein each object is composed of four equilateral triangular rigid sub-structures, each having an edge length of 2 micrometers, separated by a gap spacing of about 300 nanometers between sub-structures in a given object. The spacing between sub-structures of adjacent objects is at least about 2 micrometers and typically more than 5 micrometers. The mask pattern is made for either positive or negative resists, depending upon the type of radiation-sensitive material to be used.

Step #2: Deposit a layer of a release material having uniform thickness onto a flat, smooth substrate. An example of a practical implementation of this step is as follows: spin-coat a solution of LOR (Microchem), which is based on poly-dimethylglutarimide, onto a clean, polished surface of a 5-inch diameter flat silicon wafer and bake at 200° C. for 90 seconds, yielding a solid layer of LOR that is about 300 nm thick. Typical terminal spin speed is about 3,000 RPM with a spin time of about 45 seconds. LOR type A can be used for this layer of release material, yet other compositions, such as LOR type B, Omnicoat, and PMGI (Microchem), for this release layer could also be used. Although certain materials that can be used for the release material might have potential modes of use that involve radiation sensitivity, for the purposes of this example, the release materials are insensitive to radiation exposure and function only to provide a flat, dissolvable layer affixed to the top of the substrate.

Step #3: Onto the layer of release material described in Step #2, deposit a layer of a radiation-sensitive material containing a plurality of flexible supramolecular components that have dimensions which are large enough to span smaller gaps between proximate and aligned sub-structures within a composite object but not larger gaps between sub-structures that are parts of neighboring objects. Such supramolecular components are typically added at sufficient concentration to the radiation-sensitive material that can provide at least one or more flexible interconnections between neighboring sub-structures in a given object. Usually, it is desirable to have at least three or more interconnections between each of the pre-configured neighboring sub-structures in a given object. An example of a practical implementation of this step is as follows: Onto the LOR layer described in Step #2, spin-coat a solution of SU-8 epoxy photoresist (Microchem) containing an additive consisting of high molecular weight polymeric molecules and bake at 100° C. for 60 seconds, yielding a solid (but not cross-linked) layer of SU-8 photoresist, which contains the additive of high molecular weight polymeric molecules. After spin-coating and baking, this deposited layer of SU-8 containing high molecular weight polymeric molecules is about 100 nanometers thick. The high molecular weight polymeric molecules have maximum spatial dimensions after spin-coating that are larger than the gaps between neighboring sub-structures in a given composite object, yet smaller than any gaps between any sub-structures of neighboring composite objects. These high molecular weight polymeric molecules are also compatible with the solution of SU-8 photoresist and form a uniform solution when added to the photoresist. It can be desirable for these high molecular weight polymers to have at least some epoxy functionality so that they can potentially be crosslinked into the SU-8 photoresist in a later step.

Step #4: Onto the layer of radiation-sensitive material containing a plurality of flexible supramolecular components described in Step #3, deposit a layer of a radiation-sensitive material having uniform thickness. An example of a practical implementation of this step is as follows: Onto the SU-8 layer containing supramolecular components described in Step #3, spin-coat a solution of SU-8 epoxy photoresist (Microchem) and bake at 100° C. for 60 seconds, yielding a solid (but not cross-linked) layer of SU-8 photoresist that is about 1 micron thick.

Step #5: Using a lithographic patterning system based on spatially patterned radiation, expose the deposited layers of materials on the substrate from Step #4 to spatially patterned radiation using the mask created in Step #1 in order to cross-link the radiation-sensitive material. An example of a practical implementation of this step is as follows: Load the wafer that has deposited layers of materials from Step #4 into an Ultratech XLS i-line ultraviolet (UV) lithography stepper, load the mask created in Step #1 into same Ultratech XLS i-line ultraviolet lithography stepper (optical wavelength is 365 nm), and expose the layers of materials to patterned UV radiation formed by the mask with adequate intensity and duration to cause cross-linking of the radiation-sensitive material in the regions exposed by the ultraviolet light. The delivered energy per unit area of the UV exposure is typically about 130 mJ/cm².

Step #6: Thermally treat the exposed multi-layer deposit on the wafer substrate to ensure cross-linking (if the radiation sensitive material requires such thermal treatment). An example of a practical implementation of this step is as follows: Patterened crosslinking in the SU-8 resist, induced by the exposure to patterned radiation via the stepper, can be amplified by thermal treatment. Remove the exposed multilayer deposit connected to the wafer substrate from the lithographic patterning system, place the wafer on a temperature controlled hot-plate that provides a very spatially uniform temperature, and bake at 100° C. for 60 seconds. Remove the multilayer deposit on the wafer from the hot plate and cool the wafer having a deposit to room temperature.

Step #7: Develop the resist material to remove uncrosslinked radiation-sensitive material from the multi-layer deposit. Typically, it is desirable for this development process to be independent of the removal of the release layer under the radiation-sensitive material. The development step removes the unexposed (i.e. uncross-linked) radiation sensitive material, yet it does not remove either the exposed radiation sensitive material or the supramolecular material that interconnects cross-linked rigid sub-structures that are separated by a smaller gap spacing. An example of a practical implementation of this step is as follows: Immerse the multi-layer deposit on the wafer in a liquid solution of SU-8 developer (Microchem), such as propylene glycol monomethyl ether acetate, agitate using a rotary shaker per development instructions, remove the combination of wafer and developed deposit from the developer solution, rinse, and dry at room temperature.

Step #8: Release the complex objects consisting of sets of rigid sub-structures interconnected by flexible supramolecular structures into a fluid material by removing the release material. An example of a practical implementation of this step is as follows: Immerse the developed multi-layer deposit on the wafer in an aqueous liquid solution of LOR developer (e.g. 2.2% solution of TMAH available from Microchem), agitate for 15 minutes using a rotary shaker until the LOR release layer has been substantially dissolved, forming a dispersion of complex-shaped particles in the developer solution.

Step #9: Separate the dispersion of these complex-shaped particles in a fluid material from the wafer substrate. An example of a practical implementation of this step is as follows: Remove the wafer substrate from the dispersion of complex-shaped particles in fluid material using tweezers. Alternatively, the dispersion can be poured off and the wafer retained.

Step #10: Subject the complex objects to quiescent thermal and/or externally applied stochastic fluctuating forces that cause rearrangements of the sub-structures. The energy density of excitations is typically sufficient to bend flexible interconnections between rigid sub-structures within an object, thereby causing significant changes in relative configurations of the rigid sub-structures, compared to the initial relative configurations of rigid sub-structures within objects as fabricated on the layer of release material. An example of a practical implementation of this step is as follows: Thermal excitations cause fluctuations in the relative positions and orientations of rigid sub-structures that are interconnected by flexible interconnections within a given complex-shaped particle. These thermal excitations are present due to random stochastic thermal entropic forces that are the source of Brownian motion of colloidal structures in the fluid material.

Step #11: Attractive interactions between at least portions of rigid sub-structures and/or flexible materials within an object enable the dispersed objects that are excited by energetic stochastic fluctuations in the fluid material to form one or more desired complex configurations that are accessible by energetic stochastic fluctuations that sample one or more configurations of sub-structures that are different from the initial configuration of rigid sub-structures that were fabricated on the layer of release material. An example of a practical implementation of this step is as follows: In addition to providing some initial flexible interconnections between rigid sub-structures with a given object, the high molecular weight polymeric material extends from the non-interconnected edges of the rigid sub-structures within an object. This polymeric material can form physical entanglements, can have functionality that provide cross-linking bond, can hydrogen bond, and/or can chemically bond with other strands in order to create net attractive interaction energies between rigid sub-structures that are typically significantly stronger than the average energy of the stochastic fluctuations (e.g. thermal stochastic fluctuations). In one embodiment, a flexible polymeric silicone material that contains epoxide, hydrogen, and/or hydroxide functionalities, such as are readily available from Gelest Inc., can be utilized to create the desired flexible interconnections.

Step #12: This step may occur concurrently with Step #8, Step #9, and/or Step #10. Stabilize complex shaped particles that have reconfigured sub-structures, compared to their initial configuration prior to release, against aggregation with other complex shaped particles. An example of a practical implementation of this step is as follows: Add a surface-active agent, such as the anionic surfactant sodium dodecyl sulfate (SDS), to the dispersion of complex objects in the fluid material (e.g. to create an SDS concentration of 40 mM). Adsorption of the SDS onto the surfaces of the complex shaped particles provide a charge-stabilization and inhibit agglomeration of the dispersion of complex-shaped particles in the fluid material.

### A Second Example Embodiment of the Current Invention

A lithomeric particle comprising a plurality of solid rigid sub-structures (e.g. plates or rods) that have pre-specified shapes that are interconnected to at least one other rigid sub-structure by an interconnecting sub-structure, typically made of a deformable material, and can reconfigure to cause a change in shape of the lithomeric particle (in one or more dimensions), such that each of the plurality of rigid sub-structures, once reconfigured, can be bonded together to form a desired particle shape while also inhibited from bonding to form an undesired particle shape, wherein said lithomeric particles are typically dispersed in a fluid material. Rigid sub-structures are typically mass-produced in proximity to each other using a lithographic method. Interconnecting sub-structures are typically made of a flexible non-fluid material. Interconnecting sub-structures can be manufactured lithographically or created by coating, adsorption, or other deposition processes. A portion of the surfaces of rigid sub-structures are interconnected by flexible linking sub-structures that can bend under thermal or other externally applied energetic excitations, wherein thermal excitations, and/or other external energetic excitation (e.g. ultrasonic excitation), exist and/or are applied, thereby causing the interconnecting sub-structures and/or rigid sub-structures to deform, stretch, twist, or bend so that rigid sub-structures of a lithomeric particle are brought into proximity and can bond together into the desired particle shape. A portion of the surfaces of one or more rigid sub-structures may be treated/coated with a bonding material that is adhesive (i.e. attractive) when in close proximity to other rigid sub-structures. In some cases the rigid sub-structure material can adhere without the presence of a different bonding material; the adhesion energy between two sub-structures is typically much stronger than thermal energy (unless transient bonding is desired). Once bonded into a desired shape or range of shapes, lithomeric particles are typically stabilized by a net repulsive interaction that inhibits aggregation (i.e. agglomeration) of the lithomeric particles in the fluid material.

### A Third Example Embodiment of the Current Invention

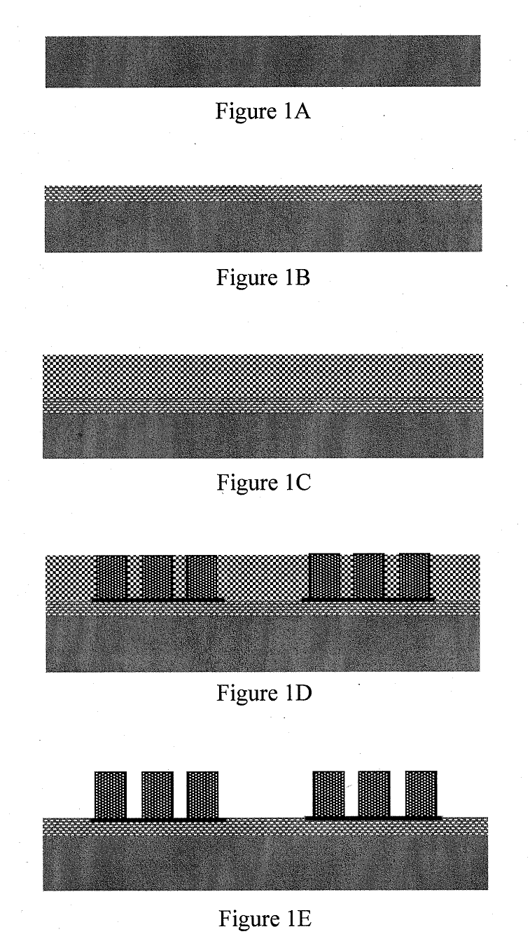

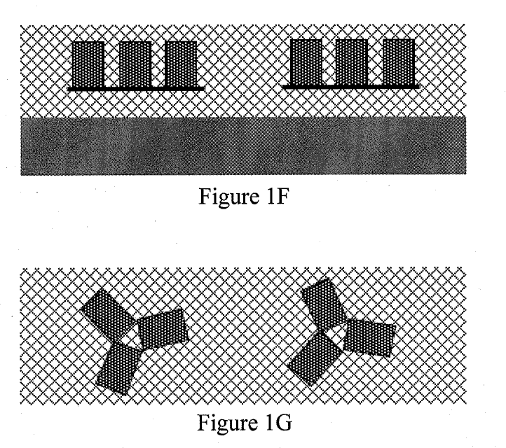

According to an embodiment of the current invention, a plurality of complex-shaped particles are fabricated using spatially patterned radiation on a flat substrate that has been coated with a layer of a release material, as shown in FIGS. 1B-1G. In this example embodiment, a thin interconnecting layer of radiation-sensitive material, which connects thicker proximate rigid sub-structures, can be flexible enough to facilitate deformation (e.g. bending) of the interconnecting material subsequent to release of the particles into a fluid material. For example, an anisotropic flow of a liquid developer in contact with an exposed radiation-sensitive material (e.g. a photoresist) creates thin interconnections between thicker, more rigid sub-structures. Due to the flexibility of the interconnecting structures, when the particle in the fluid material is excited by thermal energy and/or an externally applied energetic excitation, the interconnecting material can deform, thereby permitting certain allowed reconfigurations of the more rigid sub-structures to which it is attached according to the design of the sub-structures, interconnections, and interactions between sub-structures. Deformation of the less rigid interconnecting structures by energetic excitations enables the sub-structures to sample a range of possible reconfigurations, so that regions of sub-structures that were initially apart can move into proximity and bond, yielding a plurality of particles having a desired three-dimensional shape that is different than the initial shape created by lithographic fabrication process. The resulting 3-d lithomeric particles are typically stabilized against aggregation in a fluid material to inhibit agglomeration.

### A Fourth Example Embodiment of the Current Invention

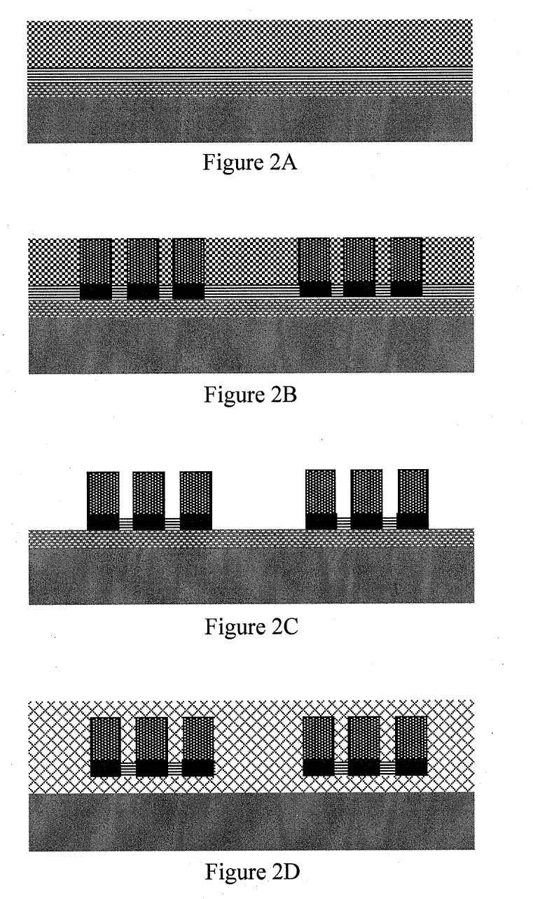

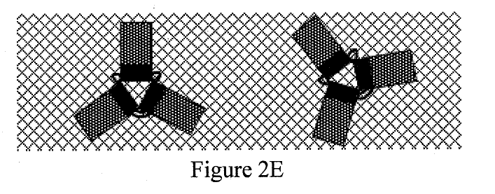

According to an embodiment of the current invention, a plurality of complex-shaped particles are fabricated using spatially patterned radiation on a flat substrate that has been coated with a layer of a release material, as shown in FIGS. 2A-2E. In this example embodiment, a thin layer of radiation-sensitive material that contains a flexible interconnecting material is deposited on the release layer. The interconnecting material has a maximum spatial dimension that is large enough to span smaller gaps between adjacent rigid sub-structures, but not larger gaps that separate lithomeric particles. After exposure, the interconnecting material is crosslinked into the radiation sensitive material in sub-structures, thereby connecting adjacent sub-structures even after development to remove unexposed radiation-sensitive material. The resulting three-dimensional lithomeric particles are stabilized against aggregation in a fluid material to inhibit agglomeration.

### A Fifth Example Embodiment of the Current Invention

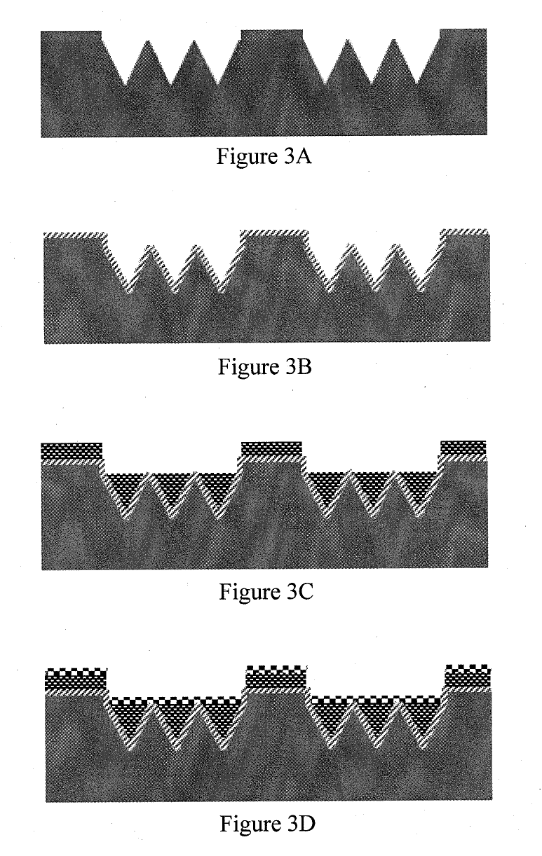

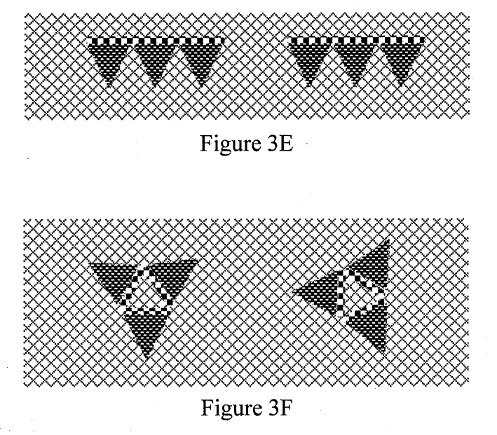

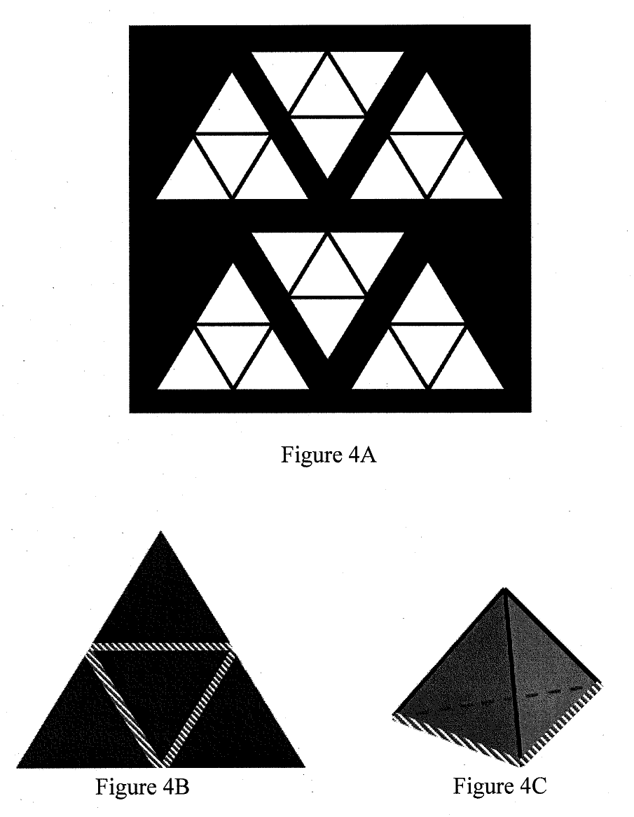

According to an embodiment of the current invention, a plurality of lithomeric particles is made using relief deposition templating. According to an example embodiment, well-deposition templating version of relief deposition templating is used to fabricate a plurality of lithomeric particles, as shown in FIGS. 3A-3F. A well-deposition template is typically fabricated to facilitate the formation of rigid sub-structures and flexible interconnections between rigid sub-structures. As shown here, the deepest part of the wells are filled with a rigid material for the rigid sub-structures, yet each well is not entirely filled. Subsequently, a second material is deposited, forming interconnecting sub-structures, thereby causing the rigid sub-structures to be interconnected. The thickness and other dimensions of the deposited second material as well as its elastic properties control the flexibility and deformability of the interconnecting sub-structures. Each of the composite lithomeric particles formed contain a plurality of rigid sub-structures connected by one or more flexible interconnecting sub-structures. Although sub-structures with each particle are interconnected, each particle remains discrete and is not connected with other particles, as controlled by the design of the well-deposition template and the deposition processes. Undercutting can be used in making the template in order to ensure that neighboring particles remain disconnected. The resulting three-dimensional lithomeric particles are stabilized against aggregation in a fluid material to inhibit agglomeration. After the plurality of lithomeric particles are separated from the well deposition template into a fluid material; thermal and/or other external excitations deform the flexible interconnecting sub-structures, enabling the rigid sub-structures to reconfigure. Optionally, rigid sub-structures within a particle that have moved into proximity bond together due to attractive interactions to form a desired three-dimensional particle shape.

### A Sixth Example Embodiment of the Current Invention

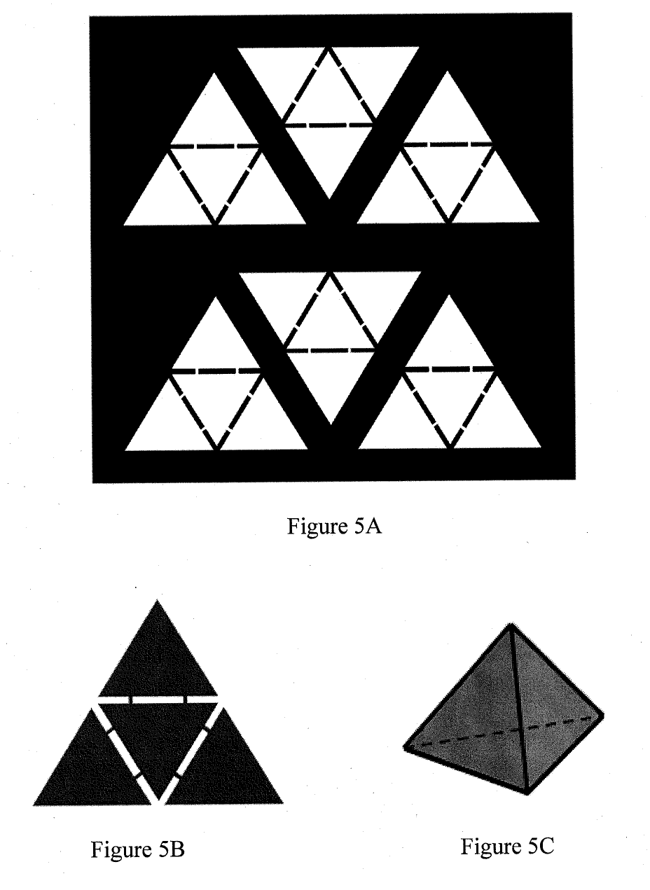

According to an embodiment of the current invention, a mask pattern is designed to be suitable for lithographically fabricating a plurality of lithomeric particles, which have the capacity to internally reconfigure through thermal and/or other energetic excitations after steps of deposition of materials, exposure, development, and release into a fluid material to form three-dimensional particles, as shown in FIGS. 4A-4C. After the particles are released from the substrate and energetic excitations cause deformable sub-structures to deform, the outer edges of rigid triangular sub-structures can adhere and bond to each other. The design of the mask pattern and fabrication of the sub-structures limit the range of angles over which the bending of the deformable sub-structures can occur under energetic excitations, thereby inhibiting or strongly reducing the possibility of encounters of the face of one rigid substructure with the face of another proximate rigid sub-structure, resulting in a high likelihood of bonding of triangular sub-structures into a desired three-dimensional particle shape (e.g. a tetrahedron). The desired particle shape is a result of a combination of design of an appropriate mask pattern, a fabrication of particles in an initial state that involves more efficient lithography, and energetic excitations that cause reconfiguration of rigid sub-structures and deformation of interconnecting sub-structures. Typically, these energetic excitations (e.g. thermal fluctuations) cause attractive edges of triangles sub-structures to move into proximity whereupon attractions cause these sub-structures to bond in a desired configuration. It is possible for the particle material for the triangular rigid sub-structures to also be a bonding material, such that interactions between edges of the rigid sub-structures are attractive and form bonds. Although only a very limited number of particles are shown in the illustration of the mask pattern of this embodiment, modern lithographic methods permit more than one billion particles to be created in parallel using a suitable mask pattern that has a basic pattern for a particle repeated over a much greater surface area.

### A Seventh Example Embodiment of the Current Invention

According to an embodiment of the current invention, a mask pattern is designed to be suitable for lithographically fabricating a plurality of lithomeric particles, which have the capacity to internally reconfigure through thermal and/or other energetic excitations after steps of deposition of materials, exposure, development, and release into a fluid material to form three-dimensional particles having a desired shape or range of shapes, as shown in FIGS. 5A-5C. Within each particle, more rigid particle sub-structures are interconnected by less rigid, deformable sub-structures in the form of strips. Subsequent to release of the plurality of particles, which were initially fabricated lithographically in quasi-planar configurations, into a fluid material, energetic excitations cause reconfiguration of the triangular particle sub-structures, enabling a portion of the triangular sub-structures to bond, thereby yielding a plurality of particles that have a tetrahedral shape that is different than the initial quasi-planar shape.

### An Eighth Example Embodiment of the Current Invention

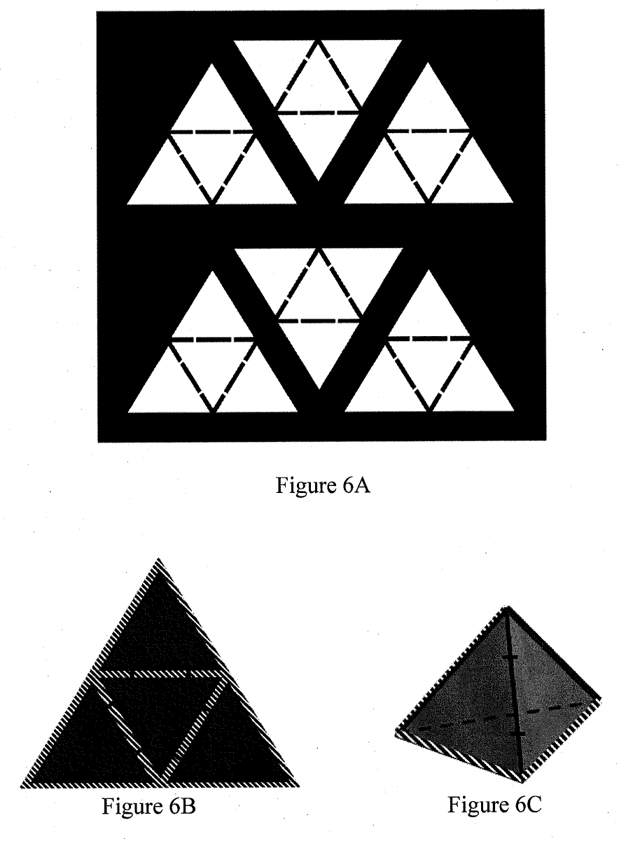

According to an embodiment of the current invention, a mask pattern is designed to be suitable for lithographically fabricating a plurality of lithomeric particles, which have the capacity to internally reconfigure through thermal and/or other energetic excitations after steps of deposition of materials, exposure, development, and release into a fluid material to form three-dimensional particles having a desired shape or range of shapes, as shown in FIGS. 6A-6C. Within each particle, more rigid particle sub-structures are interconnected by less rigid, deformable sub-structures in the form of strips. A bonding material and bonding sub-structure has been attached to the more rigid triangular sub-structures to facilitate bonding. Subsequent to release of the plurality of particles, which were initially fabricated lithographically in quasi-planar configurations, into a fluid material, energetic excitations cause reconfiguration of the triangular particle sub-structures, enabling a portion of the surfaces of the triangular sub-structures to bond, thereby yielding a plurality of particles that have a tetrahedral shape that is different than the initial quasi-planar shape.

### A Ninth Example Embodiment of the Current Invention

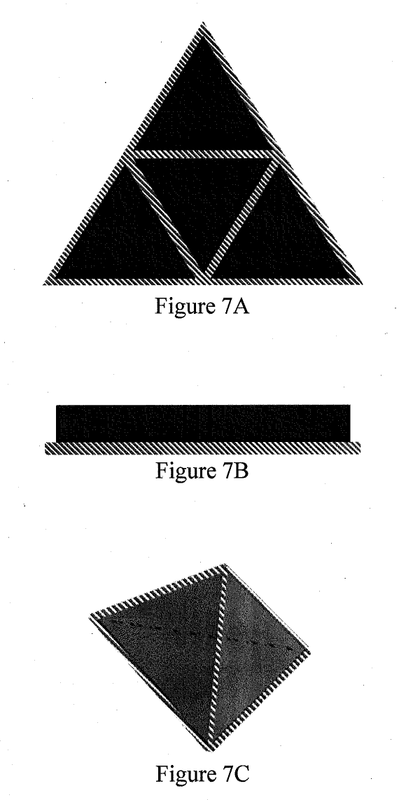

According to an embodiment of the current invention, a mask pattern similar to the one shown in FIG. 4A is used to fabricate a plurality of lithomeric particles, an example of which is shown in FIG. 7C. Four discrete triangles arranged in proximity are connected by a deformable interconnecting sub-structure that is a thin layer of a polymeric material, such that the interconnecting sub-structure of a larger triangle of interconnecting material is fabricated and aligned relative to the four more-rigid triangular sub-structures using a lithographic method. Interconnecting sub-structures are typically deformable or flexible and can also be adhesive, providing bonding functionality in addition to structural flexibility that permits reconfiguration as a result of thermal or other external energetic excitations. Flexible and semiflexible polymeric materials can be chosen to provide both functionalities, including biopolymeric materials and synthetic polymeric materials.

### A Tenth Example Embodiment of the Current Invention

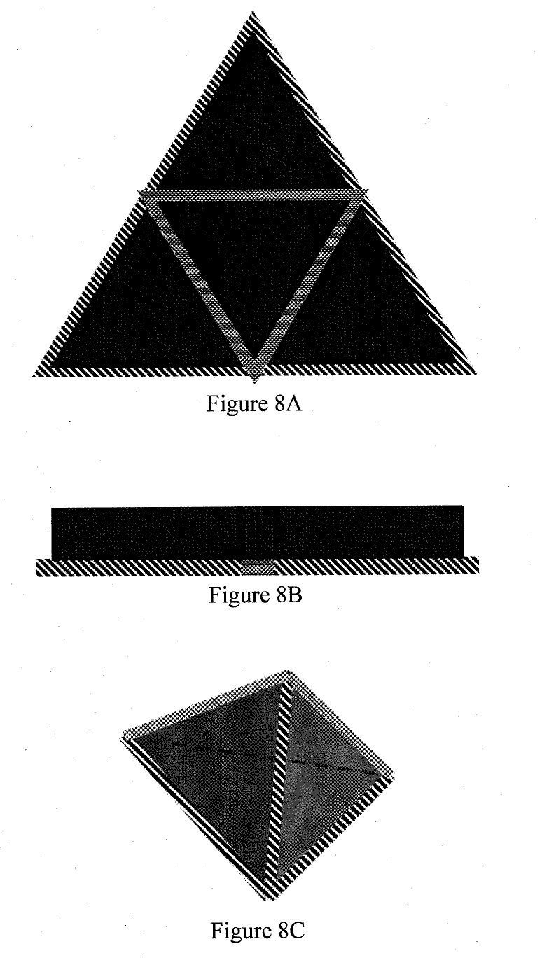

According to an embodiment of the current invention, a mask pattern similar to the one shown in FIG. 4A is used to fabricate a plurality of lithomeric particles, an example of which is shown in FIG. 8C. Four discrete triangles arranged in proximity are connected by a deformable interconnecting sub-structure that is a thin layer of a polymeric material, such that the interconnecting sub-structure of a larger triangle of interconnecting material is fabricated and aligned relative to the four more-rigid triangular sub-structures using a lithographic method. Interconnecting sub-structures are typically deformable or flexible that permits reconfiguration of more rigid sub-structures as a result of thermal or other external energetic excitations after particles have been at least partially released into the fluid material. A bonding material present at the outer bottom edges of the triangles facilitates bonding of sub-structures in a desired configuration as energetic excitations cause the more rigid sub-structures to reconfigure and explore a range of possible configurations. A wide variety of flexible and semiflexible polymeric materials can be used as deformable materials and as bonding materials, including biopolymeric materials and synthetic polymeric materials. Hinge-like deformable interconnectioning sub-structures attached at one surface, combined with geometrical constraints that have been designed by means of the mask pattern, favor reconfiguration of more-rigid triangular sub-structures towards the bottom direction. Surface treatment of the faces of the more rigid triangular sub-structures can be used to inhibit bonding of the faces of more rigid triangular sub-structures in undesired configurations. For instance, surfaces of the faces of rigid sub-structures can be functionalized or coated with poly-ethylene glycol (PEG) or with nanoparticles that create roughness, or pillars that cause faces to repel.

### An Eleventh Example Embodiment of the Current Invention

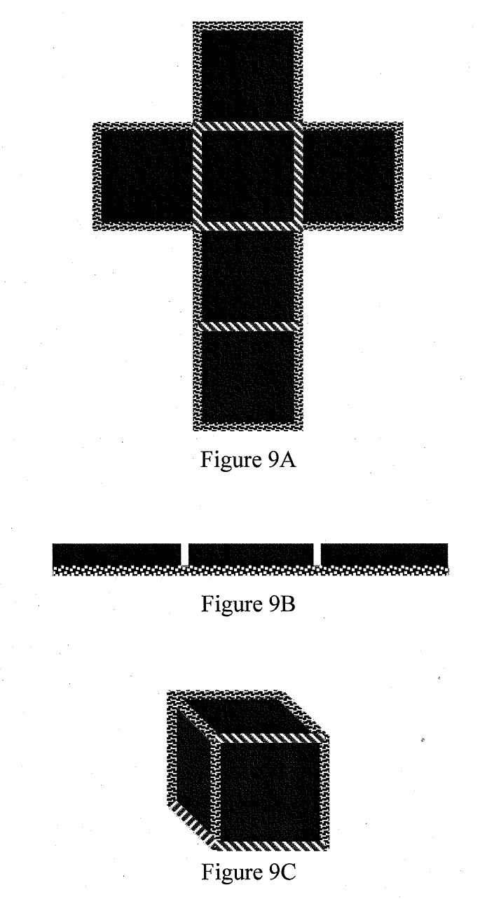

According to an embodiment of the current invention, a plurality of particles in the shape of a cube can be produced, as shown in FIGS. 9A-9C. Deformable interconnecting sub-structures between certain more rigid square sub-structures, combined with geometrical constraints created through the fabrication process, favors reconfiguration of outer square rigid sub-structures towards the bottom direction. The lower outer edge of the cross-shaped arrangement of squares is coated with a bonding material to facilitate bonding of reconfigured sub-structures in a desired shape of a cube. Surface treatment of the faces of the more rigid square sub-structures can be used to inhibit bonding of the faces of square rigid sub-structures in undesired configurations. For instance, treating the surfaces of the rigid faces with poly-(ethylene glycol) (PEG) or with nanoparticles that create roughness or pillars that cause faces to repel. Edge-edge bonding of more rigid square sub-structures, yielding a desired cubic shape, is facilitated by the bonding material.

### A Twelfth Example Embodiment of the Current Invention

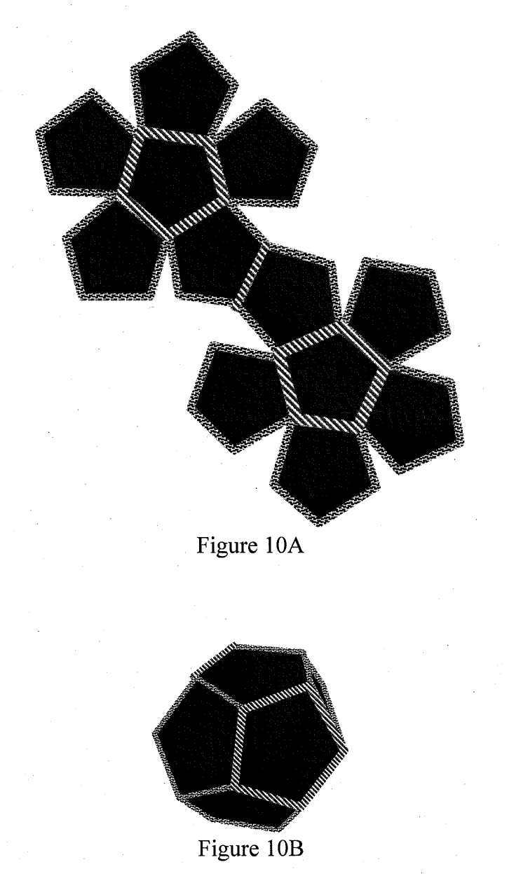

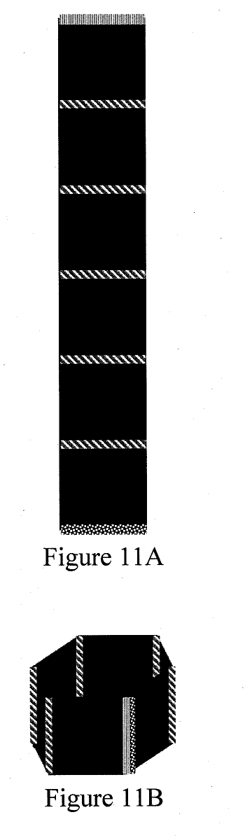

According to an embodiment of the current invention, a plurality of particles having the shape of a pentagonal dodecahedron can be produced, as shown in FIGS. 10A-10B. Deformable interconnecting sub-structures between rigid pentagonal sub-structures, combined with geometrical constraints created through the fabrication process, enable reconfiguration by energetic excitations of rigid pentagonal sub-structures from a quasi-planar initial state to yield a plurality of particles that have a dodecahedral shape. The lower outer edges of the pentagonal sub-structures are coated with a bonding material to facilitate bonding of reconfigured pentagonal sub-structures in a desired shape of a dodecahedron. Surface treatment of the faces of the more rigid pentagonal sub-structures can be used to inhibit bonding of the faces of pentagonal rigid sub-structures in undesired configurations. For instance, treating the surfaces of the faces of more rigid pentagonal sub-structures with poly-ethylene glycol (PEG) or with nanoparticles that create roughness or pillars that cause faces to repel. Edge-edge bonding of the more rigid pentagonal sub-structures, yielding a desired dodecahedral shape, is facilitated by attractive interactions between regions of the bonding material on reconfigured proximate rigid pentagonal substructures. After release from a flat substrate, energetic excitations enable each of the two open halves of the dodecahedron to form and bond through deformation of the deformable substructure that interconnects the two sets of six pentagonal sub-structures. Thus, bonding between regions of the bonding material enables a closed dodecahedron to be maintained as a final state structure even in the presence of continuing energetic excitations. According to an embodiment of the current invention, octahedra, icosahedra and other types of closed three-dimensional objects are formed through a similar process with low defect rates. Interconnecting sub-structures such as hinges at one surface plus geometrical constraints facilitates reconfiguration of the outer pentagonal rigid sub-structures towards a preferred (e.g. bottom) direction. Surface treatment of the faces of rigid pentagonal sub-structures can be used to prevent bonding of the faces of pentagonal rigid sub-structures; edge-edge bonding of rigid sub-structures by attractively interacting regions of a localized bonding material is typically desired. For instance, treating the surfaces of the rigid faces with poly-ethylene glycol (PEG) or with nanoparticles creates a surface roughness (e.g. nanoscopic pillars) that cause faces of rigid sub-structures to repel.

### A Thirteenth Example Embodiment of the Current Invention

According to an embodiment of the current invention, regions of a first complementary bonding material and a second complementary bonding material can be fabricated with respect to other particle sub-structures in order to facilitate a desired site-specific complementary bonding of particle sub-structures subsequent to reconfiguration caused by energetic excitations to yield a desired particle shape or range of shapes, as shown in FIGS. 11A-11B. Regions of a first and a second complementary bonding material are selectively affixed to chosen edges of rigid square particle sub-structures using a lithographic process. After a particle is fabricated in a quasi-planar initial state and released into a fluid material, energetic excitations drive reconfigurations of particle sub-structures, thereby enabling a desired interconnection by bonding between proximate first and second complementary bonding materials of non-adjacent square sub-structures, yielding an open particle (e.g. an open hexahedron), when thermal or externally imposed excitations bend deformable interconnecting sub-structures (e.g. flexible hinges between rigid square sub-structures), causing end terminal squares to become proximate to each other so that bonding can occur. Examples of complementary bonding materials include decorating edges with DNA that have exposed single strands, streptavidin-biotin protein interconnections, and other complementary bonding materials. Typically, complementary bonding materials that approach each other in proximity create a bond that is stronger than energetic excitations, so that desired bonds between sub-structures attached to complementary binding materials are maintained even in the presence of continuing energetic excitations.

### A Fourteenth Example Embodiment of the Current Invention

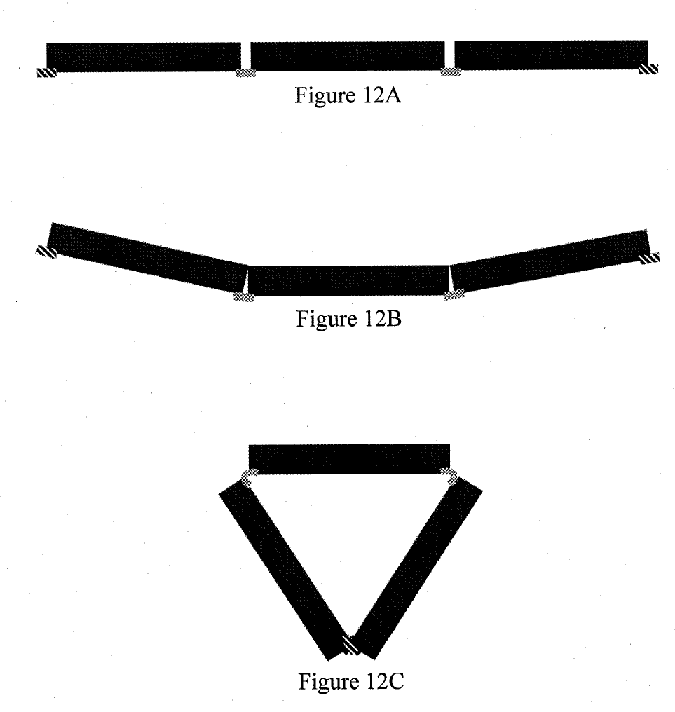

According to an embodiment of the current invention, mechanical constraints introduced by the position and attachment of deformable interconnecting sub-structures between rigid sub-structures limits the range of possibilities of reconfiguration of particle sub-structures in a desired manner subsequent to release of a particle from a substrate into a fluid material, as illustrated in FIGS. 12A-12C. Effectively, the reconfiguration of plate-like rigid sub-structures can be controlled by the design, placement, fabrication, and attachment of deformable interconnecting sub-structures to rigid sub-structures. After a particle is released into a fluid material, an initial configuration of sub-structures reconfigures as a result of energetic excitations. Deformable interconnecting substructures, such as hinges, are designed and fabricated to provide steric geometrical constraints that inhibit undesired deformations of interconnecting sub-structures, thereby effectively precluding motion of rigid sub-structures along directions that are not desired and thereby limiting bonding possibilities for bonding sub-structures made of bonding material after a particle is released from a substrate. For instance, the anisotropic range of motion of hinges can permit large deformations of interconnecting sub-structures by energetic excitations, thereby effectively allowing motion of rigid sub-structures along directions that are desired but not along directions that are not desired, so that the desired bonding can be obtained through thermal and/or other applied energetic excitations.

### A Fifteenth Example Embodiment of the Current Invention

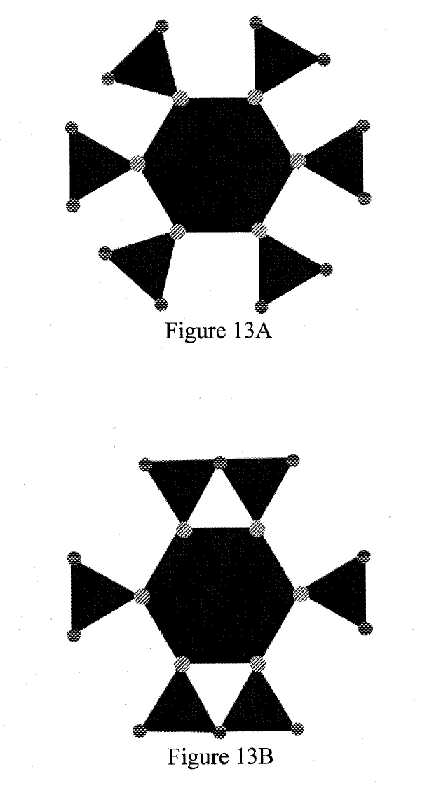

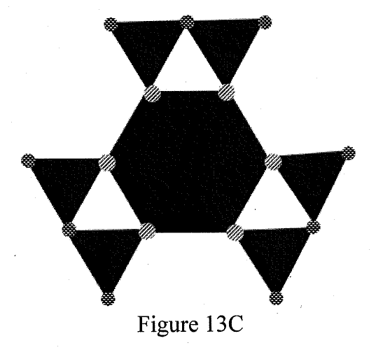

According to an embodiment of the current invention, post-release morphology changes of at least one of deformable interconnecting sub-structures and rigid sub-structures within a particle that are driven by at least one of thermal excitations and externally applied energetic excitations result in a particle that has a plurality of desired and distinguishable configurations subsequent to bonding of bonding material, as illustrated in FIGS. 13A-13C. In this example embodiment, for simplicity of demonstration of the principle, deformable interconnecting structures of a deformable material are assumed to deform only in the plane shown, so movement of the rigid sub-structures in either translation or rotation out of the plane is assumed to be prohibited. Energetic excitations cause the relative motion of the rigid sub-structures (through deformation of deformable interconnecting sub-structures). The rigid sub-structures attach in two different desired bonding configurations shown, as dictated by the placement of localized regions of a bonding material at the outermost tips of the triangular rigid sub-structures. Thus for a plurality of particles, more than one bonded configuration of sub-structures is thus obtained, even though the initial configuration of the sub-structures within the particles immediately after release from the substrate is substantially the same. For instance, a quasi-planar initial structure, containing rigid sub-structures and flexible interconnecting sub-structures (e.g. hinges) immediately after release from substrate deforms, reconfigures, and bonds into one or more desired final structures as a result of stochastic excitations (e.g. thermal excitations).

### A Sixteenth Example Embodiment of the Current Invention

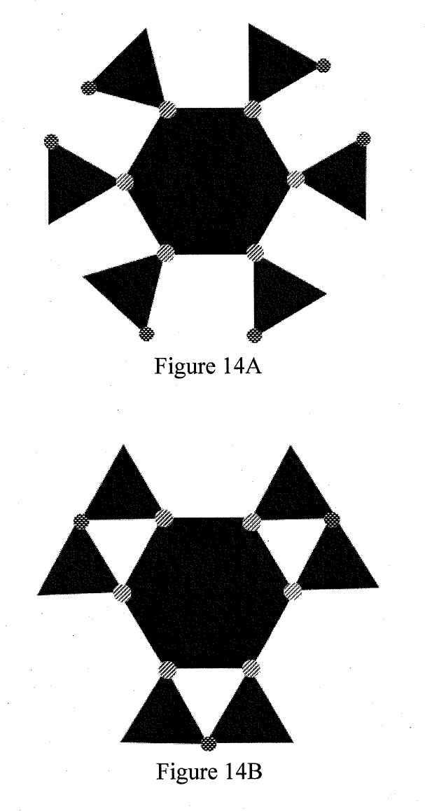

According to an embodiment of the current invention, the selective placement of a bonding material is designed and fabricated to control final configurations of particle sub-structures to obtain a final shape or range of shapes of a particle subsequent to its fabrication and release into a fluid material, as shown in FIGS. 14A-14B. In this example embodiment, for simplicity of demonstrating a principle, deformable interconnecting sub-structures are assumed to deform only in the plane shown, so movement of the rigid sub-structures through either translation or rotation out of the plane is not allowed. Thermal and/or other energetic excitations cause the relative motion of the rigid sub-structures (e.g. through the bending of the interconnecting sub-structures). The rigid sub-structures can attach in a single desired configuration shown in FIG. 14B via the specific attachment of bonding material to only certain tips of triangular rigid sub-structures. In this example, the sub-structures of bonding material have been placed in a manner that permits essentially only one bonded configuration to be formed, rather than a plurality of configurations.

### A Seventeenth Example Embodiment of the Current Invention

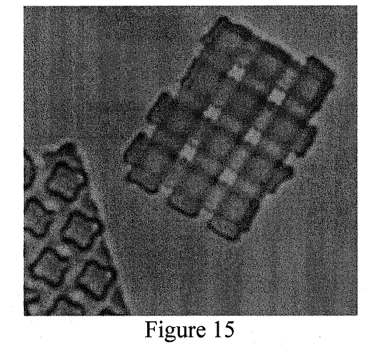

According to an embodiment of the current invention, a particle having a plurality of rigid sub-structures and of interconnecting sub-structures, is shown in an optical transmission micrograph in FIG. 15. In this example embodiment, the material for the particle's rigid sub-structures and interconnecting sub-structures is SU-8 polymer photoresist, and the particles have been released from a silicon wafer (i.e. a solid substrate) into an aqueous solution subsequent to fabrication using spatially patterned radiation by a stepper, baking, and development. A thin layer of SU-8 connects the rigid sub-structures. The lateral dimension of the rigid sub-structures within a particle is approximately 4.5 microns and the thickness of a rigid sub-structure is about 1 micron. The thickness of an interconnecting sub-structure is estimated to be less than about 100 nm.

### An Eighteenth Example Embodiment of the Current Invention

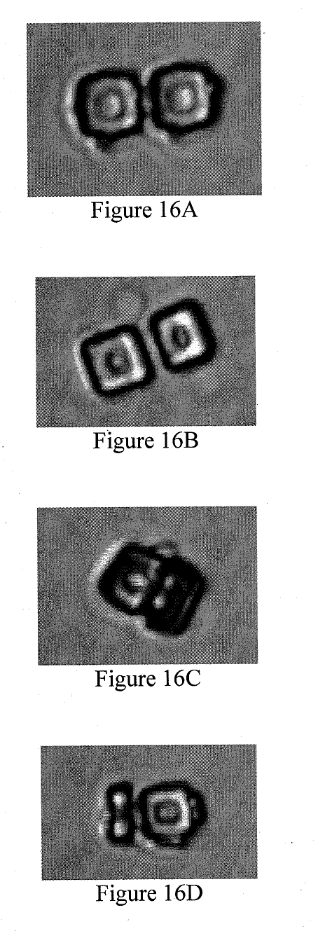

According to an embodiment of the current invention, a particle having two rigid sub-structures, each in the form of square frame (i.e. a square platelet with a hole in the middle), are interconnected by an interconnecting sub-structure that is a thin film, as shown in the optical micrographs of FIG. 16. Excitations in the form of stochastic entropic excitations and ultrasonic excitations have been applied and have provided sufficient energy to cause a deformation of the interconnecting sub-structure but not to significantly deform the rigid sub-structures. Thus, the rigid sub-structures have reconfigured as a result of the stochastic excitations. In this example embodiment, the material for the particle's rigid sub-structures and interconnecting sub-structures is crosslinked SU-8 polymer photoresist, and the particles have been released from a silicon wafer (i.e. a solid substrate) into an aqueous solution subsequent to fabrication using spatially patterned radiation by a stepper, baking, and development. A thin layer of crosslinked SU-8 photoresist connects adjacent rigid sub-structures. The lateral dimension of the rigid sub-structures within a particle is approximately 4.5 microns and the thickness of a rigid sub-structure is about 1 micron. The thickness of an interconnecting sub-structure is estimated to be less than about 100 nm This example demonstrates a range of shapes of a particle subsequent to deformation of the interconnecting material by a stochastic excitation.

### A Nineteenth Example Embodiment of the Current Invention

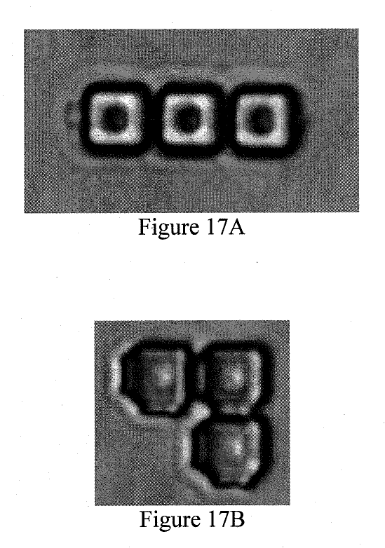

According to an embodiment of the current invention, a particle having three rigid sub-structures, each in the form of square frame (i.e. a square platelet with a hole in the middle), are interconnected by two interconnecting sub-structures that are thin films, as shown in the optical micrographs of FIG. 17. In this example embodiment, the material for the particle's rigid sub-structures and interconnecting sub-structures is crosslinked SU-8 polymer photoresist, and the particles have been released from a silicon wafer (i.e. a solid substrate) into an aqueous solution subsequent to fabrication using spatially patterned radiation by a stepper, baking, and development. A thin layer of crosslinked SU-8 photoresist connects adjacent rigid sub-structures. The lateral dimension of the rigid sub-structures within a particle is approximately 4.5 microns and the thickness of a rigid sub-structure is about 1 micron. The thickness of an interconnecting sub-structure is estimated to be less than about 100 nm. The particle having the linear arrangement of three square-frame sub-structures, as shown in FIG. 17A, is designed to reconfigure internally as a consequence of excitations in a manner that is shown in FIGS. 12A-12C. The other lithomeric isomer particle containing three square-frame sub-structures in a branched configuration, as shown in FIG. 17B, is designed to reconfigure to form half of a cube. The sub-structures of the particles remain close to a quasi-planar state immediately after being released into a fluid material until the strength of excitations is raised and/or the interconnecting material is made to be more readily deformable.

### Other Embodiments of the Current Invention

According to an embodiment of the current invention, typically, a particle material suitable for producing rigid sub-structures has a shear elastic storage modulus that is greater than at least about 10 Pa (i.e. over the desired range of temperature and pressure for which the sub-structures would be subjected). A broad range of materials can provide this desirable mechanical property. Examples of such materials include crosslinked photoresist (e.g. crosslinked SU-8 photoresist), polymeric materials, biopolymeric materials, epitaxial deposits, metals, metal alloys, inorganic materials, hybrid organic-inorganic materials, metal-organic materials, metal-inorganic materials, metal-organic-inorganic materials, reticular materials, layered materials, biodegradable materials, composite materials, and bioactive materials.

According to some embodiments of the current invention, sub-structures of lithomeric particles can also contain other functional materials, such as fluorescent dyes, phosphorescent materials, radiation-sensitive materials, bioactive materials, biodegradable materials, drug materials, bioresponsive materials, polymeric materials, biopolymeric materials, nanoparticles, magnetically responsive materials, dielectric materials, absorbing materials, semiconducting materials, insulating materials, reflective materials, conductive materials, capacitive materials, isotopic materials, photovoltaic materials, piezoelectric materials, ferroelectric materials, ferromagnetic materials, paramagnetic materials, diamagnetic materials, and inductive materials. These functional materials can be incorporated within the primary structural material for the sub-structures or can be deposited on the surfaces of the sub-structures.

According to some embodiments of the current invention, at least one of oligomeric, polymeric, metallic, inorganic, organic, organic-inorganic, metal-organic, and self-associating soft materials that offer flexibility provide desirable deformability for flexible interconnecting sub-structures. In some cases, covalent, ionic, and/or hydrogen bonding between certain extremities of the flexible interconnecting sub-structures that connect certain other rigid sub-structures. Usually, the degree of flexibility conferred by the interconnecting material is related to the density and connectivity of these materials between the rigid sub-structures. It is typically desirable for the exciting forces to be able to create deformation of the flexible interconnecting sub-structures. Some specific examples of a flexible interconnecting material are polymers, block copolymers, functionalized polymers, polypeptides, copolypeptides, block copolypeptides, oligomeric DNA, oligomeric RNA, polymeric DNA, polymeric RNA, proteins, peptoids, lipoproteins, electrolytic polymers, semiflexible biopolymers, and flexible biopolymers. In some embodiments of the present invention, it can be desirable for a flexible interconnecting material to be bio-degradable, bio-active, bio-responsive, or bio-alterable.

In an embodiment of the current invention, the interconnecting sub-structures can consist of a very thin nanoscale layer of a crosslinked polymeric material. In another embodiment of the current invention, the interconnecting sub-structures can consist of a plurality of polymeric strands that have one terminal end attached to a first rigid sub-structure and a second terminal end attached to a second rigid sub-structure that is distinctly different than the first rigid sub-structure.

According to an embodiment of the current invention, bonding sub-structures can consist of materials that have bonding, attractive, and/or associative capacities. Entanglement, crosslinking, chemical bonding, and/or physical bonding of polymeric materials can accomplish a desired bonding. Bonding can occur through at least one of the following interactions: covalent, hydrogen, pi, van der Waals, dielectric, magnetic, electromagnetic, steric entanglement, association of complementary DNA strands, association of complementary RNA strands, association of complementary peptides, bio-interactions, polymerizations, exothermic reactions, and endothermic reactions. It can be reasonably anticipated that any molecular and/or colloidal materials that have been proven to bond materials together could be used for bonding materials of sub-structures in the current invention.

According to an embodiment of the current invention, release materials that are typically useful are polymeric and/or oligomeric materials, such as LOR, PMGI, and Omnicoat, that are typically used in micro-electromechanical systems (MEMS) lithography applications for lift-off; polymeric and/or oligomeric materials, such as polysaccharides, polysiloxanes, dextrans, and resins (e.g. SU-8 resin); metals, such as silver, gold, copper, platinum, and palladium, typically deposited using processes such as sputtering, electron beam evaporation, electrodeposition, and/or electroplating; alloys of metals; inorganic films, such as silicon dioxide and silicon nitride, that can be created using surface reaction chemistries, plasma exposure methods, and/or vapor deposition methods; semiconducting materials, both doped and undoped. Typically, after deposition, the release material is a solid material that has a significant elastic shear modulus greater than about 100 Pa and can be desolidified and/or removed through a release processing step at a later stage. Typically, the release material provides a solid surface suitable for further deposition steps.

According to some embodiments of the current invention, inorganic materials, such as polished quartz, silicon, sapphire, and amorphous glass are suitable for use as a substrate. Glass-ceramic materials, such as Zerodur®, could be used. Metals could also be used. Polymeric materials could also be used. Cleaved mica offers another alternative. Although a flat, polished surface that is much larger than a single complex-shaped particle generally facilitates the production of a plurality of complex-shaped particles, one can reasonably anticipate that curved and patterned substrates could be used effectively, too.

According to some embodiments of the current invention, the fluid material is typically at least one of a liquid, a liquid solution, a liquid crystal, a polymeric solution, a surfactant solution, a complex fluid, a buffer solution, a gas, an aerosol, an emulsion, a nanoemulsion, and a supercritical fluid. Some examples of fluid materials include liquid water, alcohols, hydrocarbon liquids, silicone liquids, fluorinated liquids, ferrofluids, and liquid solutions that contain a dissolved species or dispersed colloidal materials. Such liquid solutions can contain a stabilization material (e.g. a surfactant, a lipid, or a polymer); aqueous solutions can have a preselected pH, a preselected ionic content, and a preselected dispersed material (e.g. to provide a surface coating to released particles).

According to some embodiments of the current invention, a stabilization material can contain at least one of the following: an ionic surfactant, a non-ionic surfactant, a zwitterionic surfactant, a cationic surfactant, an anionic surfactant, a protein, a lipoprotein, a lipid, a nanoparticle, a polymeric stabilizer, a di-block synthetic surfactant, a peptide, a co-polypeptide, a diblock co-polypeptide, a peptoid, a single stranded DNA, a double stranded DNA, an amino acid sequence, a fluorinated molecule, a functionally terminated biomolecule, a functionally terminated synthetic molecule, and an adsorptive material. Typically, the stabilization material is attached to or adsorbed onto at least a portion of a lithomeric particle, and it inhibits undesired aggregation of two or more lithomeric particles in the fluid material without causing undesired reconfiguration of internal sub-structures within a particle.

According to some embodiments of the current invention, at least one of the following lithography methods can be employed to fabricate sub-structures of complex-shaped particles: spatially patterned radiation methods (e.g. ultraviolet radiation exposure using a mask aligner, a lithographic stepper, a focused laser mask writing system, electron beam lithography, x-ray lithography, or ion beam lithography), deposition templating methods (e.g. pillar deposition templating), imprinting and stamping methods (e.g. thermal nanoimprint lithography, step-and-flash nanoimprint lithography), beam deposition methods, and patterned etching methods. In one embodiment of the current invention, the lithography system consists of a mercury i-line ultraviolet stepper (e.g. XLS by Ultratech Inc.) that is loaded with a reticle chrome/quartz mask that has been purposefully designed and patterned to contain a plurality of proximate sub-structures according to the herein description.

According to some embodiments of the current invention, sources of energy that can provide energetic excitations that can cause reconfiguration of sub-structures within a particle include but are not limited to one of the following: thermal energy, entropic energy, osmotic energy, sonic energy, ultrasonic energy, vibration energy, fluid flow energy, radiation energy, electromagnetic energy, chemical reaction energy, and gravitational energy. Although some sources of energy are typically stochastic (i.e. exhibit time-varying fluctuations in energetic excitations according to a probability distribution of energy and frequency of energetic excitations) and can be characterized by an average energy density (i.e. energy per volume) that can cause reconfiguration of sub-structures, the complete distribution of energy density as a function of frequency can play an important role in determining which configurations of sub-structures can be accessed as a result of the energetic excitations. Typically, the energetic sources are transmitted to the sub-structures through the fluid material in which they are dispersed. In the case of chemical reaction energy, the sub-structures are reconfigured by chemical reactions that can occur in the fluid material, at the surface of the sub-structures (e.g. catalytic reactions of hydrogen peroxide at the surface of a platinum-coated sub-structure), within the sub-structures, and combinations thereof. If an external energetic source (e.g. ultrasonic excitation) is applied, typically thermal energetic excitations will also be present, and a combination of two or more energetic excitations can cause desirable reconfigurations of sub-structures.

According to an embodiment of the current invention, a plurality of complex-shaped sub-millimeter particles, which have reconfigured from an initial configuration of proximate rigid sub-structures created by a lithographic process into one or more final configurations as a result of energetic excitations which have caused the reconfiguration of at least a portion of the particle sub-structures, are mass-produced. The process of reconfiguration typically occurs when at least a portion of the sub-structures of a particle are at least partially liberated from a lithographic substrate into a fluid material that enables the reconfiguration of the sub-structures within an object when energetic stochastic fluctuations occur. Typically, this reconfiguration is accompanied by at least one of flexing, bending, extension, contraction, compression, shear, elongation, expansion, twist, dilation, and strain of a interconnecting sub-structural material that connects at least a portion of one or more particle sub-structures. Typically, one or more desired final configurations of particle sub-structures can be obtained as a result of energetic excitations by designing an appropriate initial configuration of particle sub-structures and interconnections; in particular, it can be advantageous to deposit a bonding material, possibly in a manner that provides localization within a particle, which can offer non-specific or specific (e.g. complementary) attractive interactions, on one or more portions of sub-structures.

According to an embodiment of the current invention, a lithomeric particle comprising a plurality of solid rigid sub-structures (e.g. plates or rods) that have pre-specified shapes which are interconnected to at least one other rigid sub-structure by a flexible material and can reconfigure to cause a change in shape of the lithomeric particle (in one or more dimensions), such that each of the plurality of rigid sub-structures, once reconfigured, can be bonded together to form a desired particle shape while also inhibited from bonding to form an undesired particle shape, wherein said lithomeric particles are typically dispersed in a fluid material.

According to an embodiment of the current invention, a portion of the surfaces of rigid sub-structures are interconnected by flexible linking sub-structures that can bend under entropic or other externally applied energetic excitations, wherein entropic excitations, and/or other external energetic excitation (e.g. ultrasonic excitation), exist and/or are applied, thereby causing the interconnecting sub-structures and/or rigid sub-structures to deform so that rigid sub-structures of a lithomeric particle are brought into proximity and can bond together into a desired particle shape. A portion of the surfaces of one or more rigid sub-structures may be treated or coated with a bonding material that is adhesive (i.e. attractive) when in close proximity to other rigid sub-structures. In some cases the rigid sub-structure material can adhere without the presence of a different bonding material; the adhesion energy between two sub-structures is typically much stronger than thermal energy (unless transient bonding is desired). Once bonded into a desired shape, said lithomeric particles typically possess a net repulsive interaction with other lithomeric particles that inhibits their aggregation (i.e. agglomeration) in the fluid material.

According to some embodiments of the current invention, both open and closed shell particle designs are possible through control of size, shape, relative positions, relative orientations, and relative interconnections of rigid sub-structures. Typically, rigid sub-structures are made of a material having an elastic modulus that is at least an order of magnitude larger than an interconnecting material that interconnects rigid sub-structures. Thermal energy or some other form of external exciting energy effectively deforms the interconnecting material enough to enable the rigid sub-structures to come into proximity and be bonded together in a desired conformation to yield a desired particle shape or range of shapes. Some rigid sub-structures do not have to be bonded to other rigid sub-structures: they can be attached to a lithomeric particle only through flexible interconnecting material; these sub-structures can explore a variety of configurations under thermal or other external excitations. A variety of types of interconnections between rigid sub-structures can be made. Examples of types of interconnections can include but are not limited to the following: (1) hinge connection: edges of interconnected sub-structures are attached by a flexible material, such as a polymeric or oligomeric adhesive, or a fine flexible metallic, organic, or inorganic material; (2) single-point connection: a single point connection allows multiple relative rotations of interconnected rigid sub-structures; and (3) tethered connection: one or a few molecules on neighboring strands are bonded to another sub-structure or become entangled with similar or complementary molecules on another sub-structure.

According to some embodiments of the current invention, a bonding material is activated to form a bond between sub-structures by external causes, such as changes in at least one of pH, salt concentration, ionic strength, radiation intensity, electromagnetic radiation, ultraviolet light, depletion agents, dialysis, and solvent exchange, leading to control over bonding, and the order of bonding, by the application of an external activating stimulus

According to an embodiment of the current invention, the deformability of an interconnecting sub-structure can be controlled by a combination of the elastic modulus of the interconnecting material, the number of interconnections between rigid sub-structures, the sizes and shapes of interconnections, and the locations of the interconnections.

According to an embodiment of the current invention, it is desirable to increase the deformability of an interconnecting sub-structure within a particle that has been fabricated lithographically subsequent to the release of the particle in a quasi-planar state from a solid substrate into a fluid material. The increase in the deformability of an interconnecting sub-structure of a particle dispersed in a fluid material can be achieved by changing at least one of temperature, pressure, osmotic pressure, pH, ionic strength, composition, solvent quality, concentration of dissolved material, and concentration of dispersed nanoparticulates. In an embodiment of the current invention, an additive material is added to the fluid material in order to weaken an elastic material property of an interconnecting sub-structure within a particle, thereby facilitating deformation of the interconnecting sub-structure by an excitation (e.g. a stochastic excitation) that is applied subsequent to adding the additive material to the fluid material. This weakening of an elastic material property of an interconnecting sub-structure of a particle can be at least one of a swelling, a shrinking, a dissolving, a molecular cleaving, an etching, a partial removal, an unbinding, and a partial disconnection of an interconnecting sub-structure.

According to an embodiment of the current invention, a hysteretic material that retains a memory of a particular deformation state as a function of a control parameter is used as a material for fabricating a sub-structure within a lithomeric particle. Examples of such hysteretic materials included thermal memory materials, elastic memory composites, and shape-memory materials. Typically, hysteretic materials are used for interconnecting sub-structures in a particle and can be used to control the shape of the particle from one state to another by internal reconfiguration of sub-structures.

According to an embodiment of the current invention, an optically responsive material that deforms in response to optical illumination is used as a material for fabricating a sub-structure within a lithomeric particle. An example of an optically responsive material is a material that contains molecular sites that can be cleaved through the illumination of the material by optical electromagnetic radiation that has an appropriate intensity and wavelength. Another example of an optically responsive material is a material that contains molecular sites that can be crosslinked through the illumination of the material by optical electromagnetic radiation that has an appropriate intensity and wavelength, subsequent to a desired deformation that is created by a non-optical excitation. Thus, using an optically responsive material, the internal configurational states of sub-structures can be altered in a desired manner by controlling the illumination of the particle with electromagnetic radiation.

According to an embodiment of the current invention, a customized anisotropic particle, which has a customized shape, customized size, and customized composition, is fabricated using at least one of a lithographic method, an optical lithographic method, a patterning method, an etching method, an irradiation method, an imprinting method, an extrusion method, a templating method, a stamping method, a nanoimprinting method, a direct-write method, a deposition templating method, a relief deposition templating method, a relief radiation templating method, a patterned plate imprinting method, a bottom-up particle synthesis reaction in solution, a crystal growth method, an erosion method, and a deformation method.

According to an embodiment of the current invention, a custom-shaped particle that has been released into a fluid material and has a non-initial configuration as a result of excitation is suitable for use as a topical health-improving agent (PCT/US09/066,428 which claims priority to 61/193,469 all of which are incorporated herein by reference). Such particles typically have a range of shapes that facilitate embedding into skin (e.g. pointed or barbed shapes) and typically have a composition that includes a bio-interactive ingredient (e.g. drug molecules). Such bio-active ingredients are typically incorporated into the composition of sub-structures of a complex-shaped particle. A triangular tetrahedron is an example of a simple pointed particle shape that can be created through reconfiguration of lithographically fabricated sub-structures from a quasi-planar state.

According to an embodiment of the current invention, an entropic depletion attraction is used to cause at least one of a deformation of an interconnecting sub-structure within a particle and a bonding of a first sub-structure within a particle to a second sub-structure within the same particle. Moreover, the shapes of sub-structures of a particle can be designed to provide portions of their surfaces that are shape-complementary (U.S. patent application Ser. No. 12/576,089 which claims priority to 61/103,766 all of which are incorporated herein by reference), thereby facilitating selective bonding of portions of sub-structures having pre-designed and desired relative orientations and positions through a depletion attraction (U.S. patent application Ser. No. 12/524,946 which claims priority to PCT/US08/01443, 60/899,036 and 60/898,997 all of which are incorporated herein by reference). In addition, the roughness of the surfaces of sub-structures can be fabricated in order to control the strength of a depletion attraction between portions of sub-structures, thereby facilitating selective bonding between desired portions of sub-structures (U.S. patent application Ser. No. 12/739,697 which claims priority to PCT/US08/012,832 and 60/996,376 all of which are incorporated herein by reference). The strength of bonding by depletion attractions is typically controlled by the concentration, type, and size of the depletion agent as well as the area of shape-complementary portions of sub-structures within particles. A combination of the design of the shapes of portions of sub-structures within a particle with the location and degrees of freedom offered by an interconnecting structure can be used to limit the range of shapes that are energetically favored subsequent to starting an excitation.

In an embodiment of the current invention, a stochastic force exciting a particle is stronger than a force needed to deform an interconnecting sub-structure. In an embodiment of the current invention, a stochastic force exciting particles that have been at least partially released from a solid substrate provides sufficiently strong fluctuating forces over a duration of time to deform an interconnecting structure and enable a first rigid sub-structure to bond with a second rigid sub-structure in a desired manner. In an embodiment of the current invention, the strongest fluctuations of a stochastic force that excites a particle are larger than the force required to deform an interconnecting sub-structure. In an embodiment of the current invention, the strongest fluctuations of a stochastic force that excites a particle are smaller than the force required to break a bond between a first and a second sub-structure once the bond has been formed. In an embodiment of the current invention, the strongest fluctuations of a stochastic force that excites a particle are between the force required to deform an interconnecting sub-structure and a force required to break a bond between sub-structures that have previously bonded. In an embodiment of the current invention, the bonding of a first sub-structure to two or more other sub-structures creates a strong enough bond that the strongest fluctuations of a stochastic force are insufficient to reconfigure the first sub-structure and break two or more bonds between the first sub-structure and other sub-structures.

In an embodiment of the current invention, a stochastic excitation is at least one of a stochastic process, a random process, a Wiener process, a Levy process, a Markov process, a Brownian process, a continuous-time process, a time-varying process, a stationary process, a non-stationary process, a time-invariant process, a colored-noise process, and a white-noise process (Lemons, D. S. An Introduction to Stochastic Processes in Physics. Johns Hopkins University Press: Baltimore, 2002; Van Kampen, N. G. Stochastic Processes in Physics and Chemistry, 3rd ed.; Elsevier: Amsterdam, 2007). A stochastic process is typically described as being a process in which a probability distribution is required to describe a non-deterministic excitation and time evolution of a system in question. In an embodiment of the current invention, a stochastic excitation is transmitted to a particle by a fluid material, thereby causing at least one sub-structure in a particle to explore a range of possible configurations that fluctuate over time.

According to an embodiment of the current invention, the average duration over which a plurality of particles reconfigures as a result of stochastic excitations before attaining a non-fluctuating non-initial shape as a result of one or more bonding events is less than twelve hours. This duration is typically made shorter by increasing the strength of stochastic excitations, provided that this increase does not inhibit bond formation or even causes existing bonds to break. According to an embodiment of the current invention, the stochastic motion of a sub-structure as it reconfigures within a particle is describable by a set of dynamical Langevin equations that includes both stochastic forces and stochastic torques acting on the sub-structure, typically in the body frame of the particle.

According to an embodiment of the current invention, a strain associated with a deformation of an interconnecting sub-structure between a first rigid sub-structure and a second rigid sub-structure, which is caused by a stochastic excitation process, is at least 1%. According to an embodiment of the current invention, a change in a relative orientational angle of a first rigid sub-structure with regard to a second rigid sub-structure, which is caused by a stochastic excitation process, is at least one degree. According to an embodiment of the current invention, a change in a distance between a center of mass of a first rigid sub-structure with respect to the center of mass of a second rigid sub-structure, which is caused by a stochastic excitation process, is at least one nanometer. A strain characterizing a deformation is typically at least one of a bending strain, a contractile strain, an extensional strain, an elongational strain, a twisting strain, a shear strain, and an expansive strain.

According to an embodiment of the current invention, an entropic stochastic excitation process at temperatures between about 200 K and about 1000 K is sufficient to produce at least a 1% strain of deformation of an interconnecting sub-structure of a particle, such that said interconnecting sub-structure has at least one spatial dimension that is less than about 100 nm. According to an embodiment of the current invention, at least one of a force and an energy of an entropic stochastic excitation process is controlled by a temperature of a particle in thermal contact with at least one of a solid substrate, a release material, and a fluid material. According to an embodiment of the current invention, a stochastic excitation process produces fluctuating stochastic forces having an average force that is typically less than about one microNewton such that said fluctuating stochastic forces excite at least an interconnecting sub-structure of a particle.

We claim:

1. A method of producing a particle, comprising:
fabricating a precursor particle structure comprising a first sub-structure, a second sub-structure proximate said first sub-structure and an interconnecting sub-structure connected to said first and second sub-structures, said precursor particle structure being in a first configuration; and
exposing said precursor particle structure to a stochastic excitation process to cause a deformation of said interconnecting sub-structure to reconfigure at least one of a position and an orientation of said first sub-structure relative to said second sub-structure from said first configuration to form said particle in a second configuration,
wherein said first sub-structure and said second sub-structure are substantially free of deformation during said exposing; and
wherein a maximal spatial dimension of said particle in said second configuration is less than about one millimeter.

2. A method of producing a particle according to claim 1, wherein said maximal spatial dimension of said particle in said second configuration is less than about 10 micrometers.

3. A method of producing a particle according to claim 1, wherein said stochastic excitation process is an entropic stochastic excitation process.

4. A method of producing a particle according to claim 2, wherein said fabricating is at least one of a lithographic method, a templating method, an imprinting method, a stamping method, an extrusion method, an embossing method, a relief deposition templating method, a pillar deposition templating method, a well deposition templating method, a spatially patterned radiation exposure method, an etching method, a relief radiation templating method, a particle templating method, a two-patterned surface imprinting method, a bottom-up solution synthesis method, and a patterned deposition method.

5. A method of producing a particle according to claim 1, further comprising dispersing said particle into a fluid subsequent to said fabricating.

6. A method of producing a particle according to claim 5, wherein said fluid comprises at least one of a gas, a supercritical fluid, a liquid, an aqueous liquid, a non-aqueous liquid, an isotropic liquid, an anisotropic liquid, an oil, a liquid mixture, a liquid solution, a liquid solution of amphiphilic molecules, a surfactant solution, a micellar solution, a solution containing stabilizer molecules that provide stability against particle aggregation, a complex fluid, a viscoelastic fluid, a liquid crystal, a polymeric solution, a liquid solution of amino acids, a liquid solution of ribonucleic acids, a liquid solution of polypeptides, a liquid solution of diblock copolypeptides, a lithographic developer liquid, a lithographic etching liquid, an acidic liquid, a basic liquid, a chemically reactive liquid, an aqueous solution of protein, an aqueous solution of single-stranded DNA, an aqueous solution of double stranded DNA, an aqueous solution of oligomeric DNA, an emulsion, a nanoemulsion, a solution containing biologically active molecules, a solution containing drug molecules, and a colloidal dispersion in a liquid.

7. A method of producing a particle according to claim 5, wherein said stochastic excitation process is at least one of a random excitation, a periodic excitation having a time-varying amplitude, a pulsed excitation, an entropic excitation, an ultrasonic excitation, a sonic excitation, a vibrational excitation, an electrical excitation, a magnetic excitation, an electromagnetic excitation, an optical excitation, a biological excitation, a flow excitation, a compressional excitation, a shear excitation, a pressure excitation, a cavitation-driven excitation, a turbulent excitation, a chemically driven excitation, a pH-driven excitation, and a collisional excitation.

8. A method of producing a particle according to claim 1, further comprising bonding at least a portion of said first sub-structure to at least a portion of said second sub-structure of said particle to fix at least one of a position and an orientation of said first sub-structure relative to said second sub-structure, subsequent to said exposing.

9. A method of producing a particle according to claim 8, further comprising fabricating a bonding sub-structure comprising bonding material such that said bonding sub-structure is attached to at least one of said first sub-structure, said second sub-structure, and said interconnecting sub-structure.

10. A method of producing a particle according to claim 1, wherein said deformation is at least one of a shear deformation, an extensional deformation, a plastic deformation, an elastic deformation, a transverse deformation, a longitudinal deformation, an elongational deformation, a strain, a stretching, a dilation, a contracting, a bending, a flexing, a twisting, a torsion, a compression, and an expansion.

11. A method of producing a particle according to claim 4, further comprising, prior to said fabricating, providing a solid substrate having at least a portion of a surface coated with a release material.

12. A method of producing a particle according to claim 11, wherein said particle having said precursor particle structure is released from said solid substrate by at least one of a removing, a dissolving, a developing, a degradation, an etching, a reacting, a heating, a cooling, a melting, a sublimation, a chemical reaction, and a phase change of said release material.

13. A method of producing a particle according to claim 1, wherein at least a portion of a shape of at least one of said first sub-structure, said second sub-structure, and said interconnecting sub-structure is designed and fabricated to provide a portion of a desired shape of said particle in said second configuration.

14. A method of producing a particle according to claim 8, wherein said second configuration of said particle subsequent to said bonding defines an internal compartment within said particle that is at least partially enclosed by said first sub-structure and said second sub-structure.

15. A method of producing a particle according to claim 2, wherein said particle comprises at least one of an organic material, an inorganic material, a metallic material, an organic-inorganic material, an electrically conducting material, a magnetically responsive material, a semiconductor material, a dielectric material, a birefringent material, an electrically insulating material, a thermally insulating material, an energy storage material, a bio-compatible material, a bio-degradable material, a bio-inert material, a bio-resistant material, a bio-polymer material, a bio-erodible material, a bio-nutrient material, a bio-inhibitor material, a bio-catalytic material, a bio-reactive material, a bio-responsive material, a bio-digestible material, a bio-absorbable material, a bio-derived material, a protein, an enzyme, a vitamin, a nutrient, a collagen, a gelatin, an albumin, an actin, a tubulin, a polypeptide, a copolypeptide, a polysaccharide, a starch, a modified starch, a porous material, an elastic material, an extensible material, a functionalized material, and a biopolymer material.

16. A method of producing a particle according to claim 4, further comprising providing a pre-designed lithographic mask having a mask pattern prior to said fabricating, wherein said pre-designed lithographic mask facilitates said fabricating of at least one of said first sub-structure, said second sub-structure, and said interconnecting sub-structure of said precursor particle structure of said particle.

17. A method of producing a particle according to claim 1, further comprising fabricating a plurality of precursor particle structures, each comprising a first sub-structure, a second sub-structure proximate a corresponding first sub-structure and an interconnecting sub-structure connected to respective said first and second sub-structures; and
exposing said plurality of precursor particle structures to a stochastic excitation process to cause a deformation of each said interconnecting sub-structure to reconfigure at least one of a position and an orientation of each said first sub-structure relative to a corresponding said second sub-structure to form a plurality of particles.

18. A method of producing a particle according to claim 1, wherein said exposing causes said first sub-structure and second sub-structure to reconfigure by varying degrees of deformation of said interconnecting structure such that said particle in said second configuration exhibits a shape that fluctuates in a stochastic manner over time.

19. A method of producing a particle according to claim 5, further comprising adding a depletion agent to said fluid to cause said bonding.

20. A method of producing a particle according to claim 8, further comprising adding a depletion agent to said fluid to cause said bonding.

21. A method of producing a particle according to claim 5, further comprising adding a stabilizing agent to said fluid to inhibit agglomeration of said particle when there are additional similar particles present in said fluid.

22. A method of producing a particle according to claim 12, further comprising adding a stabilizing agent to said fluid to inhibit agglomeration of said particle when there are additional similar particles present in said fluid.

23. A method of producing a particle according to claim 1, wherein said stochastic excitation process causes a strain of said deformation of said interconnecting sub-structure to exceed about 1%.

24. A method of producing a particle according to claim 5, wherein a temperature of said fluid is changed to alter the strength of said stochastic excitation process.

25. A method of producing a particle according to claim 5, wherein a composition of said fluid is changed to make said interconnecting sub-structure more readily deformable.

26. A method of producing a particle according to claim 1, wherein at least one of a thickness, a width, a length, and a minimal spatial dimension of said interconnecting sub-structure is less than about one micrometer.

27. A multi-component composition, comprising:
a first material component; and
a plurality of particles produced according to claim 2 and dispersed in said first material component,
wherein a maximal spatial dimension of each of said plurality of particles is less than about 10 micrometers, and
wherein said plurality of particles is at least 10 particles.

28. A multi-component composition according to claim 27, wherein said first material component comprises at least one of a fluid, a liquid, a polymeric solution, a biopolymer solution, a surfactant solution, a micellar solution, a ferrofluid, a liquid crystal, a dispersion, a mixture, a gel, an emulsion, a nanoemulsion, and a solution, such that said multi-component composition forms a stable dispersion of said plurality of particles in said first material component.

29. A multi-component composition according to claim 27, wherein at least one of said plurality of particles contains at least one of a therapeutic material, an anti-fungal material, an anti-viral material, an anti-bacterial material, an anti-microbial material, an anti-wart material, an anti-blemish material, an anti-cancer material, and an anti-burn material, such that said multi-component material is a health-improving agent.

30. A multi-component composition according to claim 27, wherein at least one of said plurality of complex particles contains at least one of an electrically conducting material, an electrically semi-conducting material, an electrically resistive material, and an electrically insulating material, such that said multi-component material is an electrically functional material.
